(19) United States
(12) Patent Application Publication
(10) Pub. No.: US 2018/0200552 A1
(43) Pub. Date: Jul. 19, 2018

(54) FIRE CONTAINMENT SYSTEM, DEVICES AND METHODS FOR SAME AND FOR FIREFIGHTING SYSTEMS

(71) Applicant: Shalom Wertsberger, Rochester, NY (US)

(72) Inventor: Shalom Wertsberger, Rochester, NY (US)

(21) Appl. No.: 15/853,825

(22) Filed: Dec. 24, 2017

Related U.S. Application Data
(60) Provisional application No. 62/446,833, filed on Jan. 16, 2017.

(51) Int. Cl. A62C 37/40; A62C 37/36; A62C 37/46; G08B 17/02

(52) U.S. Cl. CPC A62C 37/40; G08B 17/02; A62C 37/46; A62C 37/04

(57) ABSTRACT

An automatic fire containment system is disclosed, together with certain components which may be used therewith. An embodiment of the system attempts to provide fire suppressant to regions surrounding a fire zone, thus containing the fire within limited area, but not flooding a larger area than necessary to contain the fire. Sprinklers which may be selectively automatically activated electrically, optionally in addition to common heat triggering, are also provided. Sensors may be embedded in the sprinklers. Further provided are sprinkler capable of reporting activation thereof via electrical state change. Further provided are devices to reduce installation costs and increase the resolution of firefighting and/or fire containment systems by providing wireless communications between network nodes such as flow switches, valve status switch, and individual sensors, sprinkler, and other ports, and a control panel/controller.

### RELATED APPLICATIONS

This application claims the benefit of priority of U.S. Provisional Patent Application No. 62/446,833, filed Jan. 16, 2017. This application is incorporated herein by reference in its entirety.

### FIELD OF THE INVENTION

Aspects of this invention is generally directed to firefighting systems, and more particularly to fire containment systems providing control of various elements of the fire suppressant distribution system to contain fires and limit damage caused thereby, as well as to sprinklers and control equipment utilized in firefighting and/or fire containment systems.

### BACKGROUND OF THE INVENTION

Firefighting systems, especially such that utilize sprinklers are common. In most sprinkler systems the fire suppressant is water, and for brevity, these specifications would use the water as equivalent to any fire suppressant. Sprinkler systems distribute fire suppressants via a distribution system in response to a sprinkler activation which commonly results from exposure to heat in the sprinkler immediate environment, or to other sensors such as smoke, heat, combustion gas, or flame sensor, and the like, and combinations thereof. Sprinkler systems may generally be divided to two major categories, namely wet and dry type sprinkler systems.

In wet type sprinkler systems pressurized water are supplied to the sprinklers at all times when the system is armed. A heat sensitive elements holds each sprinkler closed, commonly by being coupled directly or indirectly to a closure element such as a plug. When the ambient temperature increases beyond a certain level, such as will happen during a fire, the heat sensitive element trips and releases the closure element, allowing water to flow from the sprinkler. The water are commonly dispersed by a deflector to cover a larger area. The water is thus sprayed unto the fire and the fire is hopefully extinguished.

In dry type sprinkler systems a control valve holds the water before the distribution system, which is normally dry. When a fire is detected, the control valve opens and water are allowed into the distribution system. Common sprinklers in dry systems are either similar to the sprinklers of a wet system, or open nozzles. In a system that utilizes open nozzles water will spray from all nozzles exposed to the pressurized water.

FIG. 1 represent schematically a simplified exemplary sprinkler system. The drawing depicts diagrammatically a cross-section of a structure 1 protected by a sprinkler system 2. Pressurized water is supplied from a source such as municipal water mains, a tank, and the like, and arrive at the system by a mains pipes 5. The mains supply pipe is coupled to a main valve arrangement 10. The main valve arrangement 10 commonly comprises a master valve and several valves and peripheral arrangement commonly known as ‘trim’ (Not shown). As the main valve arrangement depends on the system type details are not shown, and will be clear to the skilled in the art, as well as fully documented by fire protection standardization organizations (such as the National Fire Protection Association in the US, by way of example).

A fire alarm system 240 is commonly installed within the structure. The fire alarm may be coupled to numerous optional devices such as heat and smoke monitors, and is commonly also coupled to an alarm arrangement which is activated in response to the activation of the firefighting system.

The main valve 10 is coupled to the distribution system which includes a main distribution pipe commonly known as a riser 15. In many firefighting systems branches (B1, B2, . . . Bn) are connected to the ‘riser’. A plurality of sprinklers 20 are coupled to the branches. In certain firefighting systems a branch valving arrangement 25 is utilized for controlling the flow into a branch. Only two branches are shown as utilizing a valving arrangement are shown in FIG. 1 however branch type valving may be present in any number of point in the system, as deemed needed by the system design. Branch valving arrangement 25 commonly incorporate an alarm sensor, a shutoff valve, and other equipment, dictated by the nature of the system, design parameters, code requirements, and the like. Commonly, certain aspects of the branch valving, such as flow detectors, and the like are wired to the fire alarm system 240, commonly implemented in a panel referred to as fire alarm control panel (FACP). FIG. 1 also presents five items i1-i5 to symbolize random items that require protection from fire.

In a wet type system water are present at all the sprinklers. Upon detection of a fire such as for example in item i1, the sprinkler above i1 would likely be the first to sense the elevated heat, and trigger. Thus the water would be directed at item i1. Item i2 may receive minor spray. If item i2 catches fire as a result from the fire at i1, sprinklers above it will only trigger when their ambient temperature exceeds the triggering temperature of each sprinkler.

In certain types of firefighting systems, mostly of the dry type, when fire is detected the water are immediately distributed through all the distribution system. In certain cases the branch valving is configured to limit the flow only to certain branches.

However the concept in sprinkler system is either to deal with the local of the fire or with large portions, potentially even the whole system, in response to a fire.

A basic assumption of firefighting systems is that the principle action of the system is fire ‘fighting’. However a basic assumption underlying the fire containment aspect of the present invention is that the principle action of the fire containment system is fire control and containment, with minimalized damage to souls and property, which acts in cooperation with, or which takes priority over the firefighting function.

At the root of such assumption is firstly the concept that an item or a region that is already on fire is likely damaged behind repair by the time it causes a sprinkler to trip. At the same time, indiscriminant distribution of water may damage other items or regions that are not endangered if the fire of the first item is contained before the fire reaches those items and regions.

A known firefighting method is known as defensive attack, commonly referred to as ‘surround and drown”, which is directed to limiting exposure of nearby structure, when the risk of entering a burning structure is deemed too risky to firefighters. This method accepts major loss to the structure under fire but enables firefighters to limit surrounding damage. However such method is generally to be determined by the firefighters upon arriving at the scene and not automatic.

Therefore, there is a need heretofore unanswered for a fire containment and damage limiting system which will minimize damage both from fire and from water or other extinguishing agent that may damage items being protected. Yet a further need exists for sprinklers, systems, and supporting equipment to improve fire containment. Furthermore, a need exist for sprinklers capable of communicating their own activation to a remote station such as a controller, so as to provide better control of the fire, speed up system activation, provide early and more localized alarms, and optionally improve fire containment. Moreover there is an ongoing need to reduce system and installation costs of firefighting and/or fire containment systems, fire alarm systems, and the like.

### SUMMARY

To meet at least some of the needs listed above, there is provided a fire containment system for protecting a protected volume, the system comprising: a controller; a fire suppressant distribution system couplable to a pressurized fire suppressant supply, the fire suppressant distribution system being at least partially in the protected volume and having a plurality of distribution ports each being associated with at least one region of the protectable volume, the ports being coupled to the controller and capable of being activated thereby for releasing fire suppressant at least into their respective associated region; a plurality of sensors disposed in the volume, at least a first sensor of the plurality of sensors being associated with a first region of the volume, the first sensor being in data communication with the controller and capable of communicating thereto a condition associated with detection of a fire event; the controller being adapted to activate a set of ports to disperse fire suppressant in response to detection of fire event by at least the first sensor, the activated set containing at least a first port in a region spatially adjacent the first region.

Optionally, the activated set contains at least one port in the region associated with the first sensor.

Optionally, the first sensor comprises a sprinkler, which acts as a port and as a sensor or have a sensor associated therewith. It is noted that the term sprinkler as used herein is also colloquially referred to as a ‘sprinkler head’, and a ‘fire sprinkler’, and comprises a heat trigger mechanism or another sensor to sense the fire and open the port for fluid distribution. The sprinkler is in fluid coupling with the distribution system, and in certain types of firefighting systems known as ‘wet sprinkler system’ where fire suppressant is present in the distribution system at all times the system is in standby, activation thereof causes at least an initial dispersion of fire suppressant in the region associated therewith. Optionally the sensor associated with the sprinkler detects the fire event and communicates the existence thereof to the controller and the controller subsequently activates the sprinkler and/or other ports responsive to the fire detection event.

Optionally the activated set comprises a plurality of ports situated at least partially laterally surround the first region. Further optionally the activated set comprises ports above the first region, and/or below the first region. Thus fire containment may be achieved not only by surrounding the fire in the lateral dimension but also in the vertical dimension. As a main principle behind this aspect of the invention is to contain the fire, the aim is to surround it, including optionally above and below the fire affected region.

Optionally at least one of the ports comprises a valve in fluid communication with at least one nozzle, the valve being capable of selective activation by the controller. In certain embodiments the valve outlet constitute the nozzle, and in others the at least one nozzle is fluid-wise coupled to the valve by piping. The port may also comprise a sprinkler capable of being selectively activated by the controller.

Optionally at least the first sensor, and/or at least one of the ports is coupled to the controller via wireless communication link. In certain embodiments at least the first sensor and/or at least the one of the ports is coupled to the controller by a wired link. In certain embodiment the wired link is capable of accommodating communications from a plurality of addressable nodes. In certain embodiments the sensor is capable of communication of data to the controller, and in others the sensor communicates to the controller a state, such as open or closed switch, known current and/or voltage level, resistance, capacitance, and the like. In some embodiments such sprinkler and/or sensor is capable of wirelessly transmitting information and/or receiving information to and/or from the controller. The wireless transmission may be from the sensor to at least one intermediate station which relays the information to the controller by wire or wirelessly, or a direct wireless connection to the controller. The intermediate station may be a sensor, a port, a repeater, a concentrator, or another station capable of communicating with the sensor and/or port. Wireless transmission may be embodied in a radio, sonic, ultrasonic, and/or light. Wired Intra-pipe transmission may also be utilized by embedding a wire inside the pipe, and/or utilizing the pipe as a conductor. Sonic transmission in the pipe material is also considered. In other embodiments the communication may be wired, and in some embodiments the communication comprises any combination of wired and wireless communication.

Aspects of the invention are applicable to dry systems as well as to wet systems. In certain embodiments the fire containment system further comprises a controllable master valve disposed to control fire suppressant flow to the distribution system, the master valve is capable of being activated at least by the controller to introduce fire suppressant into the distribution system. Such systems are known as ‘dry sprinkler system’. In certain embodiments the master valve is further being capable of being activated by hydraulic activation responsive to pressure changes in a pilot system. Optionally, the pilot system is embodied at least partially by the distribution system. Optionally the fire containment system further comprising a controllable release valve coupled fluid-wise downstream from the master valve and further coupled to the controller and activated thereby in response to fire detection event, the release valve operational to vent fluid contained in the distribution system or a portion thereof, and the control valve introducing fire suppressant into the distribution system responsive to the venting.

In some embodiments at least one of the plurality of sensors is selected from a group consisting of a heat sensor, a gas sensor, a smoke sensor, combustion gas sensor, flame sensor, video sensor, ionization sensor, and any combination thereof. In some embodiments the sensor communicates a fire detection event to the controller, and in some embodiments information sensed by the sensor is transferred to the controller and processed thereby, to determine the existence of a fire detection event. Optionally a single embodiment may incorporate at least a first sensor which communicates to the controller a fire detection event and a second sensor transferring information to the controller, wherein the controller process the information to determine the existence of a fire detection event.

In some embodiments the controller is integrated with, or comprises, a fire alarm control panel (FACP). In some preferable embodiments the controller selects the activated set according to a rule set.

Optionally, the rule set or a portion thereof is dynamically changeable.

In certain embodiments the fire containment system comprises at least one condition sensor selected from a weight sensor, a video sensor, a Radio Frequency Identification Sensor, a bar code sensor, a Quick Response reader, a tag reader, a manual or automated switch, and any combination thereof, and/or any other sensor capable of sensing conditions and/or content in the protected volume. The condition sensor is coupled to the controller and communicating thereto status information relating to at least one condition of and/or content of at least a region of the protected volume and/or its environment. Optionally the rule set is being modified responsive to the status information. In certain embodiments utilizing such changeable rule set the rules are changed automatically, responsive to the status information. Optionally the information of one or more of the condition sensors may be communicated to the controller via one or more intermediate device, such as an amplifier, an analog to digital converter, a processor, a transmitter, a receiver, a signal shaper, a signal conditioner, a signal interpreter, logic gates, a communication device, and/or other circuitry.

In certain embodiments the rule set is manually modifiable. Optionally the rule set is modifiable manually prior to or subsequent and responsive to a change in the status information.

Optionally the region associated with at least the first sensor is modifiable. Further optionally the region associated with the at least one sensor is modified responsive to the status information.

In some embodiments common triggering methods and devices are also utilized, in cooperation with the controller and sensors. Thus, by way of example common dry valves, sprinklers, actuators, accelerators, control chamber controlled valves such as diaphragm valves and the like, may be utilized as known in the art in addition to, or cooperate with, the controller, sensors, and ports. In some embodiments legacy firefighting systems and the present invention are integrated, which means that the firefighting system has certain portions thereof acting as a fire containment system, having addressable ports.

As described, in some embodiments the controller operates according to a set of predetermined rules and selects ports to be activated according to the set of rules. The rules may provide either predetermined or programmatically computed a set of ports and the controller is configured to activate ports at least surrounding a region or regions having a fire event detected therein. Such computation may be computed ahead of time, manually inserted or edited, or be computed at the time of fire detection. In optional embodiments the controller is further provided with status information about the content of the region associated with a fire event, and activate ports selected in accordance with the status information. By way of example the status information may indicate that a dangerous cargo is present in a certain region, or that the temperature in a certain protected region is above or below a predetermined level. In some embodiments the controller is further provided with information about the content of at least one region other than the region in which and wherein, in response to a fire event, activate ports selected in accordance with the content information. Such arrangement may be utilized with specifically sensitive content or due to other criticality of the region, such as structural elements which may be harmed by a fire.

In any case of a fire an alarm is oftentimes desired, either directly to alert people in the immediate vicinity or indirectly, at a remote site such as a fire station and the like. Thus optionally the controller is further configured to selectively activate at least one alarms in accordance with the region or regions associated with a detected fire event. In certain embodiments a fire alarm system 240 is incorporated with the controller.

In some embodiments at least one of the plurality of sensors comprises a pressure sensor for sensing drop in pressure in a portion of the distribution system and such drop exceeding certain parameters is considered a fire detection event. Optionally a fire event is detected by having a pressure in a separate pipe disposed in the protected volume vary beyond a preset threshold.

In certain embodiments the controller is provided with spatial information regarding the topology of the protected volume and at least a part of the division to regions thereof, and the controller computes ports to be activated in accordance to the spatial information.

In an aspect of the invention there is provided a method of fire containment utilizing a system comprising a fire dispersant distribution system dispose at least partially within a protected volume, the distribution system having a plurality of controllable ports each associated with at least one region of the volume to be protected, and operable or triggerable by a controller, and a plurality of sensors disposed within the protected volume and being in communication with the controller, the method comprising the steps of detecting an occurrence of a fire event by at least one sensor of the plurality of sensors, the sensor being associated with a first region; and activating at least one port in a region adjacent to the first region.

In an optional embodiment the method further comprise the step of activating a plurality of ports in a plurality of regions disposed adjacent to the first region, to at least partially surround the first region. The plurality of regions may be disposed laterally adjacent to the first region, above the first region below the first region or any combination thereof.

In certain embodiments the method further comprises the step of providing a set of rules and having the controller select a plurality of region for activating additional ports therein, in response to fire event and conformant with at least one of the set of rules. Optionally at least of the regions for activation are selected according to a criteria consisting of at least one parameter selected from distance from the first region, content of at least one region, number of simultaneously active fire events, location of simultaneously active fire events, time of day at which fire events occur, time of year at which a fire event occur, local weather at which fire event occur, and any combination thereof.

In certain embodiments of the methods at least one of the ports comprises an electrically activated sprinkler. In some embodiments such a sprinkler may also act as a sensor. In some embodiments the controller receives input from at least one sensor in a region where at least one port was activated after a fire event, the input relating to conditions associated with a fire event, and activate at least one port in response to the input indicating new fire event in a region, intensifying of fire detected in the first region, or in regions adjacent thereto. Preferably communication between sensors and/or ports, is encrypted. More preferably all communications to and from the controller and/or ports and/or valves that may cause directly or indirectly the activation of ports, is encrypted.

In an aspect of the invention there is also provided a remotely controlled sprinkler assembly comprising a body having an internal fluid path defined therein, the fluid path extending from an inlet to an outlet, and a controllable closure element capable at least of being moved from a sealing state where it seals the outlet for preventing pressurized fluid introduced in the inlet from exiting via the outlet, to an open state allowing the fluid introduced in the inlet to exit via the outlet; an electrically operated activator capable of controllably causing or allowing the closure element to transition from the sealing state to the open state. Optionally the sprinkler further comprises circuitry capable of receiving communications from a controller and identifying if the communications is a command addressed thereto, and responsive to a predetermined command addressed thereto to activate the electrically operated activator for transitioning the closure element, and therefore the sprinkler, from a closed to an open state. In certain embodiments the outlet comprises one or more nozzles. In some embodiments a flow deflector is disposed against at least one of the nozzles. The fluid path is equivalently referred to as a waterway regardless of the nature of the fluid flowing therethrough.

In certain embodiments the activator may be activated by a second mechanism other than by the electrically operated activator. By way of example the activator may be activated in response to exposure to temperature exceeding a pre-determined threshold. In such embodiment the sprinkler further comprises a heat sensitive triggering device, disposed to maintain the closure element in the closed state until the triggering device is exposed to temperature exceeding a predetermined threshold. In such embodiments the activation of the sprinkler is enabled by either the electrically operated activator or the heat sensitive triggering device, or a combination thereof. In other embodiments the electrically operated activator may act upon a first closure element and the second mechanism on a second closure element. In certain embodiments the operation of the activator and the triggering device may act to maintain the closure element in closed state such that activation of either the circuitry or the triggering device causes the closure element to transition to open state. The electrically operated activator and the heat sensitive trigger may operate indecently or may cooperate.

Optionally the sprinkler is further configured as a fire-event sensor. To that end the sprinkler may further comprise an embedded sensor for detecting a fire event. The embedded sensor may be an independent fire event detection sensor. By way of non-limiting example the embedded sensor may be selected from a heat sensor, a gas sensor, a smoke sensor, a combustion gas sensor, a flame sensor, a video sensor, an ionization sensor, or any combination thereof. The circuitry may be configured to activate the activator in response to input from the embedded sensor. In certain embodiments the sprinkler may comprise a plurality of embedded sensors, and the circuitry may be configured to activate the activator on any combination of one or more of the plurality of embedded sensors.

In certain embodiments, at least one embedded sensor is embodied in the heat sensitive triggering device and a detection mechanism for detecting when the heat sensitive trigger device is triggered or when the sprinkler transitions to an open state. Optionally the sprinkler comprises at least one additional embedded sensor.

In some embodiments the system controller is configured to issue closure commands for at least one port, and in certain embodiments to a master control valve to affect closure of fire suppressant to the distribution system.

In an aspect of the invention there is provided an activation reporting sprinkler comprising a body defining a fluid path therethrough the fluid path having an inlet and an outlet, a heat sensitive trigger activator, and a closure element, disposed to block fluid flow via the outlet, the heat sensitive element disposed to directly or indirectly maintain the closure element against the outlet, and allow the closure element to dislodge and transition the sprinkler to an open state in response to the heat sensitive trigger being exposed to a temperature exceeding a predetermined threshold, and a sprinkler activation monitor having at least one mechanism which changes electrical state in response to the sprinkler being opened, or stated differently, when the closure element is released. In certain embodiments the activation reporting sprinkler is combined with various embodiments of remotely controlled sprinkler as described elsewhere in these specifications.

The activation reporting sprinkler comprises a sprinkler activation monitor, operative to detect sprinkler activation, and communicate the activation to a controller and/or FACP, such sprinkler activation being considered a fire detection event. Such fire detection event may be communicated to the controller/FACP by wired or wireless transmission link or a combination thereof, and optionally via one or more intermediate devices. Optionally the sprinkler may communicate the activation in combinations with an associated addressing or location information of the sprinkler being activated.

In certain embodiments the sprinkler activation monitor comprises a flow sensor for detecting flow in or about the sprinkler. By way of example the flow detector may comprise a movable surface exposed to fluid flow before the sprinkler, in the sprinkler body, or downstream from the sprinkler outlet, wherein a movement of the movable surface to and/or from a predetermined state is considered a sprinkler activation event. In certain embodiments the movable surface comprises a deflector disposed downstream from sprinkler outlet, and exposed to fluid streaming out of the activated sprinkler outlet, the streaming fluid exerting force urging the deflector to an activated state or states the deflector being disposed to assert a sensing device when in the activated state, and not assert the sensing device when not in the activated state. Optionally the sensing device comprises a switch. Notably a switch may be asserted by either closing or opening thereof.

In some embodiments the sprinkler activation monitor comprises a closure element status monitor. In one embodiment a closure element status monitor comprises a switch which is being asserted if the closure element changes state from closed to open. The switch may be in actuated directly by the closure element or by an intermediate member or members. Optionally the closure element itself forms a portion of the switch, such as a metallic closure element completing an electrical when disposed in the open state. In one embodiments the closure element monitor comprises a wire disposed in front of, or coupled to, the closure element, the wire being sufficiently thin to be torn in response to opening of the closure element, and circuitry coupled to the wire and configured for detecting tearing thereof. Opening of the closure element is considered a sprinkler activation event to be transmitted to the controller/FACP.

In some embodiments the sprinkler activation monitor comprises a pressure sensor operational to detect pressure change in the sprinkler or in its immediate vicinity such that a pressure change exceeding a predetermined level is considered a sprinkler activation event.

In some embodiments the sprinkler activation monitor comprises a fluid presence device disposed to receive fluid from the sprinkler after the sprinkler transitions to an open state, and the detection of fluid is considered a sprinkler activation event. By way of example a fluid presence detector may comprise two or more electrodes disposed in a basin which would be flooded by the firefighting or pilot fluid of an activated sprinkler, where the resistance therebetween would change as a result of fluid presence therebetween. Similarly a fluid presence detector may comprise two parallel plates acting as a capacitor, and disposed such that fluid form an activated sprinkler would be introduced into a space therebetween, which will result in detectable capacitance change, or a short circuit.

In some embodiment the sprinkler activation monitor may comprise a switch disposed to against a triggering device or a portion thereof, and operational to switch states responsive to activation of the triggering device.

In some embodiments the sprinkler comprises an energy storage device, such as a battery or a capacitor. Optionally the energy storage device is rechargeable. Further optionally, the circuitry further comprises a storage device status measurement circuitry and the sprinkler circuitry is configured to transmit information regarding the status of the energy storage device to a remote device. In certain embodiments the sprinkler is capable of transmitting status information to a remote device, the status information may be utilized at least to establish that communication exists between the sprinkler and the remote device. The sprinkler comprises wireless, or wired communication link interface or a combination thereof, the communication link being at least capable of receiving information, for receiving the activation command of the sprinkler.

In yet another aspect of the invention there is provided a firefighting and/or fire containment system comprising a fire suppressant distribution system having a plurality of branches, at least one of the branches having a valving arrangement comprising at least one status switch, a fire alarm control panel (FACP) or a system controller capable at least activating an alarm in response to assertion of the switch, a panel concentrator electrically coupled to the FACP and and/or the controller, the panel concentrator having logic and a wireless receiver; a branch terminal coupled to the at least one switch, the branch terminal having logic and wireless transmitter, and being capable and configured of sensing the assertion of the switch and wirelessly sending a message indicating the assertion of the switch, the panel concentrator being capable and configured at least to communicate the assertion of the switch to the FACP and/or controller responsive to receiving the corresponding message from the branch terminal. Optionally the branch terminal is further configured to send a periodical message indicating its operational status, the panel concentrator is further capable and configured to receive the operational status message and communicate to the FACP and/or controller the operational status or lack thereof of the branch terminal. Further optionally the panel concentrator is integrated with the AFCP and/or the controller. Further optionally the branch terminal comprises a receiver and the panel concentrator comprises a receiver and the branch terminal and panel concentrator are capable of bidirectional communication therebetween. In optional embodiments utilizing such system capable of bidirectional communication, the panel concentrator is capable of issuing commands to the branch terminal and the branch terminal further comprises at least one electrical output port changeable in response at least one command transmitted from the panel concentrator. Preferably the panel concentrator is connectable to a plurality of branch terminals.

In certain embodiments the branch terminal further comprise a backup energy storage device such as a battery and/or capacitor, and the branch terminal is configured to transmit information regarding the status of the energy storage device to a remote device, optionally the panel concentrator. A panel concentrator and a branch terminal constitute an aspect of the invention, whether alone or in combination.

In yet another aspect of the invention there is provided a firefighting system control panel comprising a power supply, a backup energy storage device, a processor, memory readable by the controller, the memory being non-volatile and having a program executable by the processor, and a wireless communication module capable of communicating with at least one remote branch terminal, the remote branch terminal being couplable to at least one switch and capable and configured to transmit information about the state of the switch, the processor constructed, capable and configured to communicate with the at least one branch terminal and receive therefrom information relating to the status of the at least one switch, and change the processor state upon detection of a change in the status of the switch. Optionally the processor state change causes an alarm activation. Further optionally the processor state change causes an activation of at least one valve or sprinkler.

### SHORT DESCRIPTION OF DRAWINGS

The summary above, and the following detailed description will be better understood in view of the enclosed drawings which depict details of preferred embodiments. It should however be noted that the invention is not limited to the precise arrangement shown in the drawings and that the drawings are provided merely as examples.

FIG. 1 depicts a simplified exemplary sprinkler system.

FIG. 2 is a detail view of a volume protected by an exemplary sprinkler system.

FIG. 3 is a simplified block diagram of a system controller.

FIG. 4 depicts an exemplary simplified schematic flow diagram of functionality provided by the controller of FIG. 3, including certain optional features

FIG. 5 depicts a continuation of the information of FIG. 4.

FIGS. 6, 6A, 6B, 7, 8, and 8A depict various exemplary simplified embodiments of an electrically and thermally activated sprinklers.

FIG. 9 depicts a simplified block diagram of a port controller in combination with several ports and sensors.

FIG. 10A-10F depict various embodiments of activation reporting sprinklers.

FIG. 11 depicts a simplified diagram of a structure with a firefighting or fire containment system utilizing branch terminals communicating wirelessly with a panel concentrator.

FIG. 12 depicts a simplified example of branch valving arrangement.

FIG. 13 depicts a simplified block diagram of an exemplary branch terminal,

FIG. 14 depicts a simplified block diagram of an exemplary panel concentrator.

### DETAILED DESCRIPTION

As explained above a basic principle of the fire containment system aspect of present invention revolves around containing the fire and an assumption is made that the region in which the fire started sustained a damage prior to the detection of the fire, and that while the source of the fire needs to be extinguished or otherwise handled, protecting the area surrounding the fire provides the best solution for minimizing fire damage. At the same time, the principle dictates that in most environment dispersing fire suppressant over the whole volume or significant portions thereof which are distal to the fire source causes unnecessary damage while oftentimes not contributing significantly to safety or to minimizing damage, and not even to extinguishing the fire. Furthermore indiscriminate fire suppressant distribution may reduce the supply of such suppressant from the area it is most needed. Notably, the fire must be monitored, and if it continues to expand, the expanded area must again be surrounded.

Thus, in a generalized version of the fire containment system, when fire is detected in a first region, which shall be termed the ‘fire zone’ in these specifications, fire suppressant is automatically released in the immediate regions surrounding the fire zone, as well as in the fire zone, without waiting for the fire to expand to the surrounding regions. However fire dispersant is not dispersed indiscriminately throughout the protected volume. Fire expansion to the immediate surrounding regions is also monitored, and if the fire does expand to any of the immediate surrounding regions of the fire zone, the fire zone is expanded to include such region, and fire suppressant is automatically released in the regions surrounding he expanded fire zone, and so forth. Depending on the nature of the system and the volume to be protected, surrounding of the fire zone may be done laterally, and optionally vertically as well, such as above and below a fire zone in adjacent floors of a protected structure, as a design choice specific for each installation or installation type, and optionally modifiable automatically or manually.

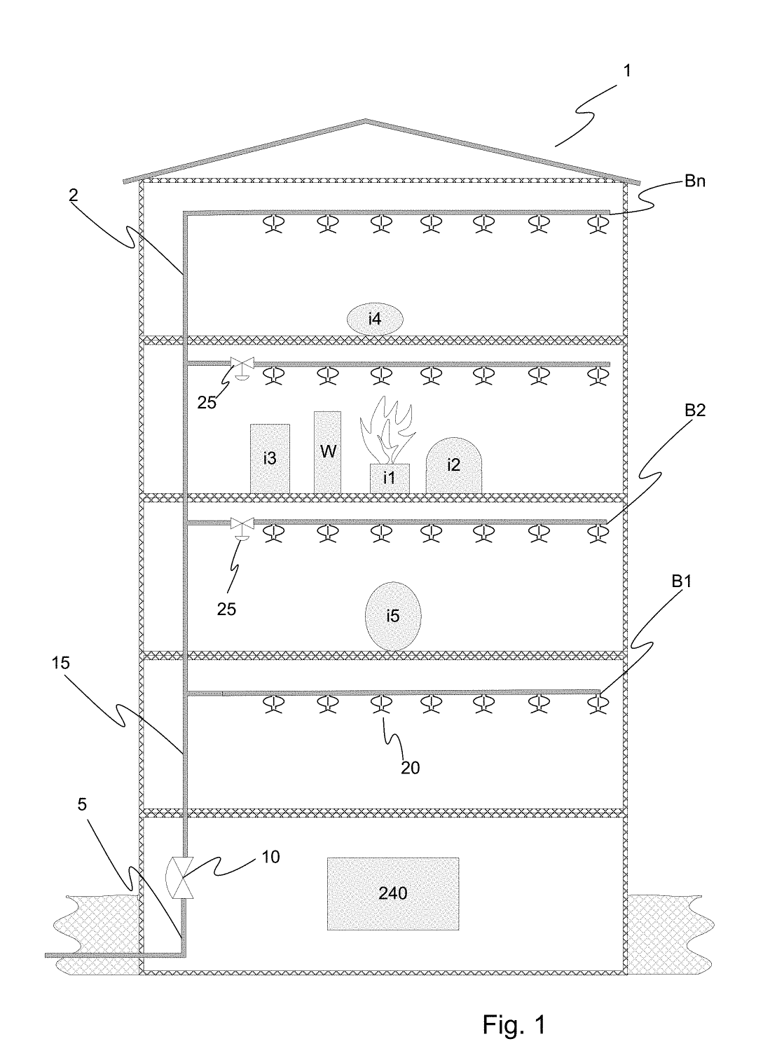

An important distinction should be made between a branch of the distribution system, as shown in FIG. 1, and a ‘region’ as described herein. A branch covers a large portion of the volume to be protected, such as a floor, a hold, a structure, and the like. In contrast a region is much smaller and defines a recognized protectable unit, and is normally characterized by a small number of fire dispersant discharge ports and sensors for sensing a fire event. While a typical region contains a single discharge port and a single sensor, this is not mandated and a region may contain a plurality of ports that are interconnected in terms of their operations. Thus, by way of example a region in a house may include a single room, or an office in an office building, a portion of a storage area in a warehouse, a portion of a hold in a vessel, a subsection of a floor in a parking garage, and the like. While for example a single room in a building may contain more than one sprinkler and more than one fire event sensor, the room may be considered as a single region, or each of the sprinklers and/or sensors may form a single region. Generally a region is considered as a volume which may be individually protected. Regions are dictated by the type of volume to be protected. Furthermore, a port may comprise a single flow control element and a single outlet, however in certain embodiments a port may also comprise a plurality of outlets. By way of example while a port may comprise a single sprinkler incorporating the flow control and the firs suppressant outlet, another port may comprise a solenoid valve coupled to a pipe with one or more outlets for example such that the ports would direct fire suppressant to different parts of a specific object. An example of such arrangement is when fire suppressant is directed to a single tank holding flammable material in a tank farm. As fire in the tank would expand rapidly to cover the tank, it would be desired to release suppressant onto the tank. However under the fire containment principles described above, if the tank is on fire, fire suppressant would also be automatically distributed to the tank's surroundings, such as areas separating it from other tanks, and in certain embodiments fire suppressant may be automatically dispersed to adjacent tanks as well.

In certain regions or embodiments the detection of fire in the fire zone occurs autonomously with the detection of the fire event, and in other regions or embodiments release of fire suppressant occurs in response to the sensor detecting a fire event. In some embodiments sensors may be incorporated with the ports, and in others separate sensors are utilized. Furthermore, certain embodiments include a plurality of sensors. Thus, by way of example a first sensor may be a common heat sensitive triggering element of a common fire sprinkler, such as a fluid filled vial, while a second sensor such as a heat sensor, a smoke sensor, a flame sensor and the like may be collocated with the port, or otherwise capable of sensing fire in the same region.

The term ‘automatically’ will be utilized for an action taken by a controller coordinating operation of the system or portions thereof, while the term ‘autonomous’ activation relates to a sensor/port pair self-activating. In certain cases autonomous activation of a port is triggered by a local or a coupled sensor, and in other cases the activation is triggered by another mechanism, such as by a heat sensitive triggering mechanism similar to those which exist in known sensors.

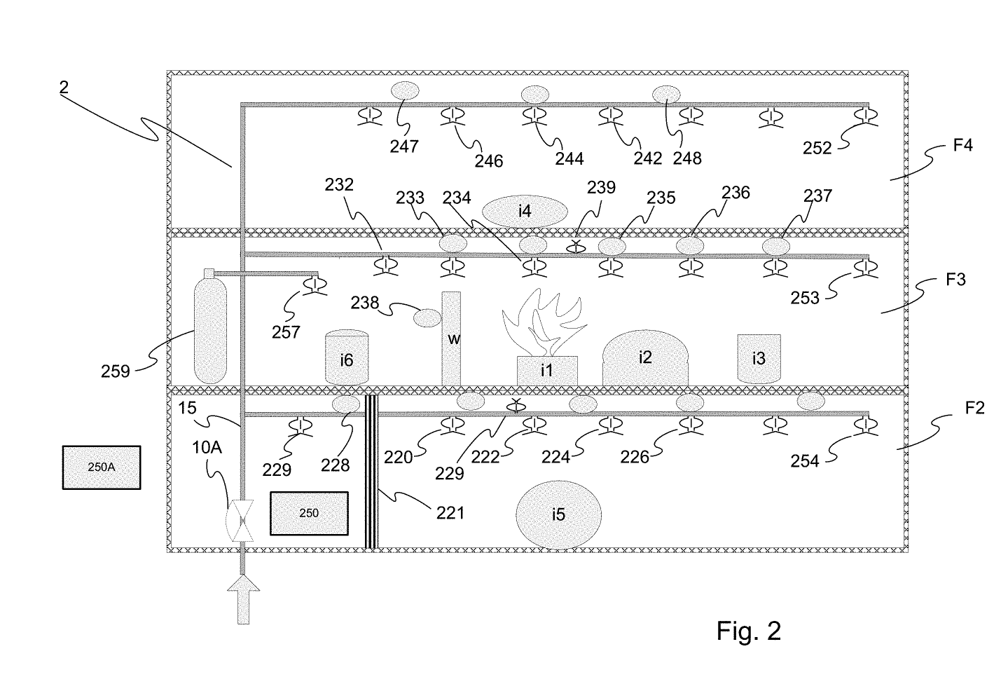

FIG. 2 is a detail view of several floors of the building depicted in FIG. 1, which will serve well to explain several features and options of the fire suppressant system aspect of the present invention. For clarity of explanation, the fire suppressant would be assumed to be water, and the ports would be sprinklers, however the skilled person would readily understand that any fire suppressant or port type may be used. While branch control valving arrangement 25 has been removed, it may optionally be used as desired. Notably the figure is provided with various features to aid understanding and presenting of features, and the arrangement does not present a limitation or disclosure to any specific implementation.

In a wet type system, water under pressure are distributed in the distribution system 2 to ports, in the three floors F2, F3, and F4 shown by way of example in FIG. 2. The water arrive via riser 15, as shown schematically by the arrow leading thereto. Individual sprinklers are indicated by their symbol, as seen by way of example by numerals 220, 222, and 224 in floor F2 in FIG. 2. Independent sensors are depicted by an ellipse such as the sensor enumerated 228 and 238. Sensors may be completely incorporated in a port such as the depicted sprinklers, or share certain elements therewith, such as power supply, computing facilities, data links, and the like. Whether completely incorporated of sharing components, such port/sensor combinations are depicted by the sprinkler symbol topped by an ellipse, such as depicted for example by enumerated sprinklers/sensors 226 and 233-237. It is noted that certain ports may be able to communicate autonomous activation, but additional sensors may be required. By way of example, if the only sensing element in a region is a sprinkler heating element which is activated, in the region where the sprinkler was automatically activated due to being adjacent to the fire zone, additional sensing capability is required in order to monitor expansion of the fire. Such monitoring may be achieved by another sensor, which in certain implementations may be a second sprinkler that has not been automatically activated, or any other fire-event sensor.

It is noted that similar arrangement may be made for dry type system, however in such systems the water are introduced to the distribution system 2 after detection of a fire, by opening of a control valve, which is a portion of the dry system valve arrangement 10 as seen in FIG. 1. In FIG. 2 the dry system valve 10A is depicted in dotted lines to indicate that such valve is not mandated in wet systems, however it may take several forms, such as differential valve, hydraulically operated clapper, gate, or butterfly valve, diaphragm valve, and the like. It is again noted that common trim varies, and is not shown. Such trim as hydraulic valve actuator and the like may provide a backup to electronic activation of various system components.

The following describes an exemplary scenario and actions taken by the system in response to different events. The example is provided merely as an example to facilitate demonstrating and explaining many features of this aspect of the invention. Some of those features are optional.

In the illustrative scenario a fire begins in Item i1 in floor F3. After some time the sprinkler 234 senses the fire. This may be done by the sensor coupled to the sprinkler (depicted schematically by the ellipse above the sprinkler symbol) or by triggering another heat sensitive triggering device. In many embodiments both options will be utilized, such that even in case that the sensor malfunctions, the common sprinkler head activating mechanism would still operate, providing fire suppression in similar manner to the systems known in the art. When the sprinkler and/or the sensor 234 detects fire it communicates the fire event in its associate region, to the controller 250. As stated supra the functionality of fire alarm 240 of FIG. 1 may be incorporated into controller 250.

When a fire event is communicated to the controller 250, the controller ascertains the location of the reporting device in the protected volume. The controller then utilizes program rules, a predetermined map, or a combination thereof, to select which ports should be activated in response. In the depicted example sprinklers 234 and 235 are likely to be activated by the controller. In some applications sprinklers 222, 244, and 245 may also be selected alone or in combination. Thus the area around the fire zone is now surrounded, but other areas of the volume are not exposed to water damage. While item i2 and potentially item i4 are exposed to water damage, the rest of the structure and other items such as i3 and i5 are not affected. In certain cases the fire zone is not completely surrounded. By way of example, if it is known that wall w would act to protect the volume containing i6, sprinkler 233 may not be activated to avoid water damage. If on the other hand item i6 is deemed susceptible to heat, sprinkler 233 may be activated together with sprinkler 232, as a preventive measure. If the floor of the structure is deemed sufficient to prevent fire from expanding to floor F2, sprinkler 224 need not be activated. While similar considerations may prevent operating sprinkler 244 on floor F4, the consideration may differ due to the location of the floor above the flames.

In certain cases in the described scenario if item i4 is heavy or flammable, upwards directed sprinklers symbolized by sprinkler 239, may be activated to reduce the risk of floor F4 collapsing onto F3 or that fire heat causing i4 to ignite. Similarly, upward directed sprinklers 229 or other ports may be activated at the floor below the fire zone to help minimizing heat damage. On another optional part provided by this scenario item i6 is partly isolated from the fire by fireproof wall w, and is of a nature which will cause severe damage if suppressant is discharged thereupon. In such case in such case sprinkler 233 will not be activated initially, despite being adjacent to the fire zone.

In certain embodiments the controller may activate ports and systems not directly coupled to the main distribution system. By way of example sprinkler 257 may be activated and discharge fire suppressant which may be the same but also differ from the fire suppressant distribution by the main distribution system. By way of example halon may be provided from a separate tank 259 to reduce the risk of fire in the enclosed or semi-enclosed space in which port 257 is disposed, to protect item i6. In certain cases, such as by way of example when sensor 228 detects a fire event in a space which is considered fire isolated form other regions, such as by fireproof wall 221, only port 229 may be activated initially.

While it is hoped that the fire is contained by the surrounding it on different directions, the fire may still expand to adjacent zones. If, by way of example item i2 ignites after the initial response of activating ports 233 and 235, there is a need to activate port 236, and perhaps even 237, according to the activation rule set. For that purpose after detecting fire in their region, port sensors 235 and/or 236 send information of another fire event to the controller, which adds the zone under port 235 to the fire zone and activates additional ports in accordance with the activation rule set. It is noted that when the fire expands the rules may differ and by way of example instead of merely activating only the first adjacent regions to the fire zone, as the fire grows ports may be activated at greater distance from the fire zone. Other similar decision may be taken as the fire grows—by way of example while sprinklers 232 and 233 may now be activated as the water damage to item i6 is considered less critical than the expansion of the fire. Stated generally, if fire events are reported from other region, and most especially if the events arrive from the immediate adjacent zones, the fire zone is expanded, the rule set is re-evaluated, and actions are taken in accordance to the rule set. The portion of the rule set relating to expanding the fire zone may differ from the portion of the rule set relating to an initial detection.

Activation of any port may be subject to more than a single fire detection event. This method, somewhat similar to common systems known as pre-action, require that fire would be detected by at least two sensors prior to activation of any port. However due to the localized discharge offered by a fire containment system according to the present invention may allow dispensing with the detection of fire event by a second sensor, especially in open nozzle dry systems.

Different levels of alarms, and adjoining actions, may be taken in accordance to specific rules. By way of example a fire event near a flammable gas storage tank may cause immediate alert to several fire stations, while a small fire in a region which have little importance may be handled by groups local to the protected volume, and the like.

Selection of activation criteria for adjacent regions may be done statically, utilizing a list of sensors and ports and their relative locations within the protected volume. In some embodiments the selection may be based purely on geometry criteria. In some embodiments the ports to be activated are selected in accordance to preset lists. By way of example a rule may be that fire event detected by a specific sprinkler/sensor would cause activation of a predetermined list of ports. Alternatively the ports to be activated may be determined computationally at any time, including the time of fire event detection. In certain embodiments the controller may be provided or sense information regarding the content of specific regions. By way of example if a vehicle carrying flammable material is known to have entered a region, a port in that region may be activated if the distance between the fire zone and the region containing the vehicle falls below a certain threshold, while on the other hand existence of fire proof structures may prevent activation of a port which would have been activated if not for that structure. Rules regarding actions to be taken in case of fire event may be static or dynamic, and may be based on static knowledge of the structure, or on dynamic knowledge received either manually or dynamically by sensors. By way of example having a floor above the fire contain heavy load or heat sensitive items may cause activating of ports directed at cooling the ceiling of the floor below, to minimize the risk of collapse or fire expanding to the floor above. The skilled in the art would recognize that the number of potential rules is endless and is dictated by analysis of each specific implementation. A graphical user interface for determining such rules or for customizing existing rules is desirable.

In certain dry type systems, such as certain pilot type systems, compressed gas is present in the distribution system while in standby state. Upon activation a master valve commonly referred to as a control valve, which may be selected of many types of dry valve types, releases water to the distribution system in response to fire events. Especially in a system combining the teachings of the present invention and firefighting system known in the art. The incoming water must make their way in a large distribution system, potentially against compressed gas, with a small relief to the gas in the system created by activated ports, and thus their arrival to the port may be delayed. In order to accelerate the arrival of water to the port one or more ports may be activated to assist in gas release. By way of example ports like 252, 253, and 254 may be selectively activated to provide gas relief. Ports 252, 253, and 254 may be regular ports such as sprinklers or controlled nozzles, or may be directed to drains.

In some embodiments the ports utilize common heat sensitive elements to block water discharge in a sprinkler. Such legacy systems may be utilized as sensing for heat in the vicinity of the port, but as they allow water discharge even if all other sensors fail, they serve as a backup to the invention disclosed herein.

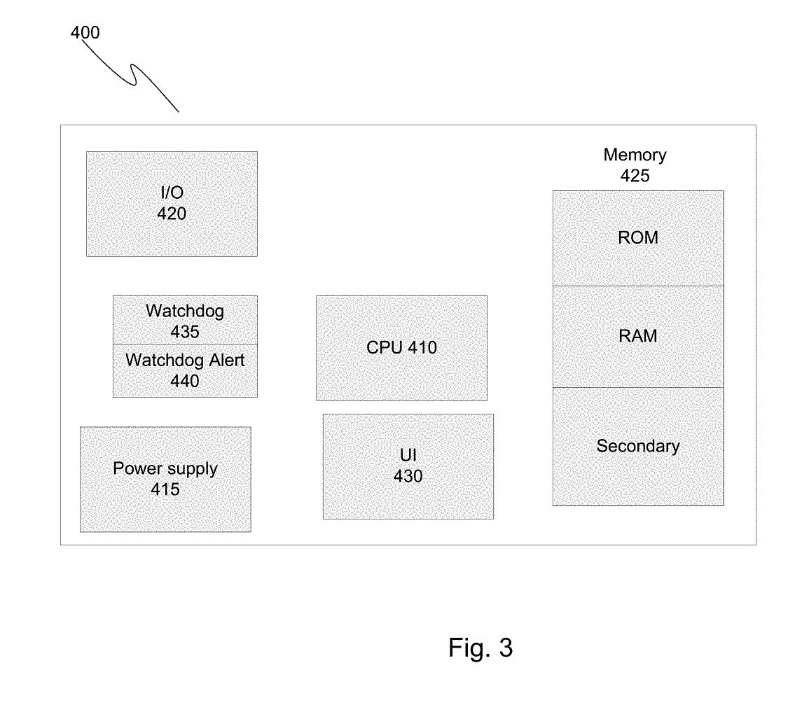

FIG. 3 depicts a simplified block diagram of a system controller 250. The controller comprises a processor 410 fed by a power supply 415. Input and output in this embodiment are handled by input/output (I/O) module 420, which potentially includes a network or other data link interface. Memory 425 stores data such as protected volume maps, rules, and programs. The controller is equipped with watchdog timer, which includes a watchdog alert handler 440. In this embodiment a separate module exists for User Interface (UI) 430. It is noted that some modules may utilize common hardware and software components, and that the depicted division is somewhat arbitrary.

The processor 410 may be any kind of programmable logic circuit capable of performing programmable tasks, either read as programs from memory or hardwire to perform a specific task. The processor may be a common microprocessor, or a programmable or masked dedicated logic device. By way of example such dedicated logic device may be a dedicated device such as Application Specific Integrated Circuit (ASIC), Masked Programmable Gate Array or any other programmable gate array (MPGA, PGA), Any Programmable Logic Device (PLD) Programmable Logic Array (PLA) or Programmable Array Logic (PAL), and the like. The logic may comprise more than a single device and may utilize support circuitry such as bridges, other interface facilities, timing devices, and the like.

The power supply 415 may be an electrical mains fed device, however preferably it also contains a backup energy store such as a battery to be used during power outages. In some embodiments the power supply is coupled to more than one power inlet to increase system availability in case of outage, such as to an emergency battery or emergency Uninterruptable Power Supply (UPS). The power supply may itself constitute an Uninterruptable Power Supply.

The I/O unit 420 may be any type of input or output circuitry capable of communicating with the various sensors and ports, and potentially other devices such as alarms, pumps, and the like, as well as other data devices. While in the embodiment depicted in FIG. 3 UI unit 430 handles communications to users and other external communications, the communication functionality of UI unit 430 may be embodied in I/O unit 420. The I/O unit may be constructed to interface with the ports and sensors via any method selected for the system, ranging from simple wires dedicated to each port and/or sensor, to wired or wireless networks, optical communications, and the like. In certain embodiments communications may occur over more than a single path.

The memory 425 will commonly be divided to non-volatile, non-transient memory which holds programs controlling the operation of various portions of the controller, and certain general rule sets, or implementation specific rule set. The memory may also comprise a read/write memory section such as Random Access Memory (RAM). That memory may be utilized for rules, status, variables used by the program and the like. The memory or portions thereof may be include or be embodied in secondary memory such as magnetic or optic devices, flash memory, and the like.

The UI portion 430 is optional, and may be incorporated into other elements already described, but the feature provided by the embodiment of FIG. 3 utilizes a separate element for interacting with users. The advantage of having a separate UI section is the functionalities caused by user interaction does not adversely affect the main function of the system, namely fire detection and containment. By way of example the UI unit may contain processing capability such as a processor, capacity for input devices such as keyboard and pointing devices, a display or display driving capabilities, and the like. Certain embodiments may also include communication capabilities such as internet or intranet, and may incorporate provisions for being remotely managed, such as by incorporating web servers, Internet of Things (IoT) software and hardware, and the like. The UI may also act as a convenient interface to enter, edit, and inspect rules and rule sets. The UI unit may include its independent input and output device such as a keyboard and display, or alternatively be responsive to a remote configuration and/or reporting program such as acting as a server for a browser, responsive to a mobile app, and the like. Preferably such communications that relate to changing system configuration or activation of system components is protected at least by passwords, and preferably by encryption.

A watchdog timer provides yet another important functionality. The watchdog timer 435 periodically monitors the processor status and is capable of taking remediation steps such as interrupting or resetting the processor in cases of malfunction. Optionally, the watchdog timer circuitry is equipped with independent watchdog alert 440 functionality, which may be used to alert personnel of a malfunction and especially of continuing malfunction of the controller. To that end the watchdog alert module may incorporate separate communication system, alarm, and optionally an independent backup power store. Watchdog timer functionality is well known in the art of microcontrollers such as controller 250. Generally watchdog timer gets periodically reset by the processor and if the timer is not reset within a given time limit one or more remediating actions are taken. In some embodiments the watchdog timer may also be utilized to monitor remote nodes and alert if a port or a sensor does not assert its operation periodically. In most of such cases the situation is reported for human intervention, but certain remedial steps may be automated.

As discussed below a system controller may be integrated with a fire alarm control panel, and/or a panel concentrator.

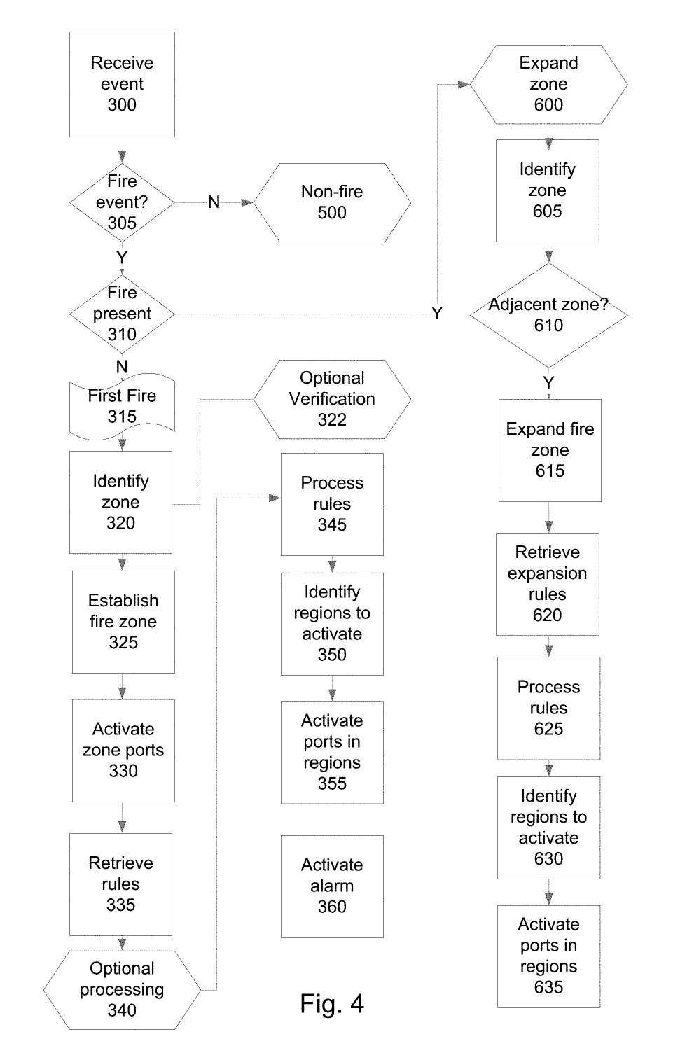

FIG. 4 depicts an exemplary simplified flow diagram of functionality provided by the controller 250, including certain optional features.

The controller 250 repeatedly monitors for events arriving through the I/O interface 420. When an event is received 300 it is tested 305 to determine if it is a fire event. If it is not a fire event it is transferred for further processing of non-fire event 500, described below. Next, a test 310 is done to determine if the system is in a state where a first fire was already flagged 315, the incoming event is assumed to be caused by expansion of the already present fire and processing is transferred to block 600 for processing expansion of the fire zone. Notably the event monitoring may also be implemented equivalently via a processor interrupt.

If the test 310 results are negative than the processor sets a flag that the system identified a fire 315, which signifies that the state of the system changed from standby to fire containment mode. The processor then identifies the zone that caused the fire event. At that stage additional verification may optionally be performed 322. Such verification may be desired to prevent nuisance tripping. Such verification may be performed by querying a second sensor in the region that caused the first fire event. By way of example if the fire event originated in a smoke alarm, a video sensor or a heat sensor in the same region may be queried, and only if there are no secondary indication of a fire the event may be discarded or a person may be alerted to further investigate the cause of the alarm. Yet another example for additional verification may be to check for a temporary condition, such as if work which would likely cause a false alarm is performed in the region. Methods and requirements of a single or double interlock may also be employed.

Once a fire is assumed to have been detected, a fire zone is established 320 in the region associated with the fire event. In the depicted embodiment, ports in the fire zone are immediately activated 330, if not active already.

The rules regarding a first fire detection in the specific region are retrieved 335 and processed 345. In certain systems, depending on the rules applicable to the relevant region, this may be sufficient and no additional ports need to be activated at this stage.

Optionally additional processing 340 takes place at that time. By way of example, if the system is aware of content in the volume to be protected, such as existence of flammable material at a distance that exceeds normal adjacent region activation, but sufficiently close to require special protection, or conversely equipment sensitive to the suppressant may be damaged and the risk is assumed low for some reason, static rules under which the system operates may be modified. The rules, either modified or as stored, are processed 345 and result in identified regions that require activation 350. Commands are then sent to ports in those region to activate and discharge fire suppressant. As described above the rules may identify regions only laterally, which considered as two dimensional (2D) operating manner. In some embodiments regions above or below the zone may be activated (three dimensional 3D). Certain ports may release fire suppressant towards the fire and certain other ports may spray cooling fluid on portions of the structure so as to reduce risk to the structure.

In step 360 an alarm is activated. The alarm may include notifying the fire department or other personnel of the existence of fire. Further optionally information about the fire events may be transmitted to a location remote from the fire site, to facilitate firefighting efforts and investigation efforts, as appropriate. Other actions may be performed such as activating emergency lighting and signage, power disconnection, automatic door locking, and the like.

If the received fire event 300 occurs when an active fire zone is already established, processing is transferred to the expand zone box 600. The region transmitting the additional fire event is identified 605. Alternatively fire zone expansion may occur manually or in response to fire continuation over preset time period. The controller then tests 610 if the new region is a zone in the vicinity the existing fire zone. If the fire event originating region is not in the vicinity of the original fire zone it is treated according to different rules. In certain cases rules may exist which link regions that are not physically adjacent, and thus the fire zone may be expanded accordingly. However if there are no relations between the new fire zone and the existing fire zone different actions may be performed, in accordance with implementation specific logic If the new fire event originated in a region adjacent the present fire zone, the fire zone is expanded 615 and rules specific to expansion of the original fire zone are retrieved 620 and processed 625. Such rules may include activating all available ports in the expanded fire zone, as well as identifying 630 additional regions requiring port activation, followed by activation 635 of such ports. By way of example fire zone expansion rules may include increasing the number of regions which are considered ‘adjacent’ to the fire zone, activating additional firefighting devices, increasing the alarm level to firefighters, and the like.

In some embodiments the system is also capable of shutting off fluid suppressant flow to the affected areas after the fire is extinguished or when it becomes clear that flow to the relevant area is superfluous, or when a determination is made that suppressant will be more effectively used elsewhere. In certain cases this task may be achieved by opening or closing selected valves, such as releasing pressure from a diaphragm chamber of a diaphragm valve, closing valves that allow pressure to escape from such diaphragm chamber, and the like. In certain cases flow of suppressant may be shut to the whole protected volume. Thus, the system continues to monitor the status and potentially the spread of fire and direct the flow of suppressant to the areas most needed, and at the optionally stop the flow of suppressant to portions or all the protected volume, to avoid additional damage and prevent waste. In such systems commonly the decision to redirect or shut off suppressant flow is done manually, but automatic apportionment of suppressant, and rules embodying such are explicitly contemplated.

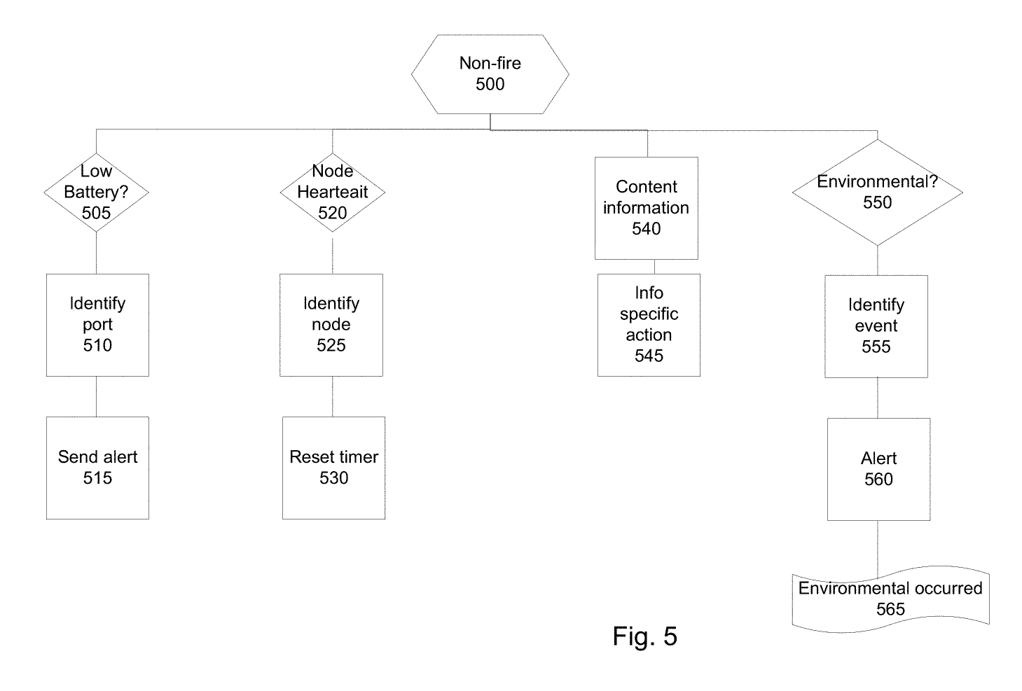

FIG. 5 is a simplified block diagram of several optional responses to non-fire events in continuation to the ‘non-fire’ event block 500 of FIG. 4

An optional non-fire event is generated if a node detects a low battery condition of its backup or main energy supply. A battery may be installed in certain sensors and/or ports and/or communication links such as a branch terminal, to function as its main energy store or a backup energy store. Such node can monitor the status of the battery or mains power and communicates a low status of either a battery or mains power as an event. The controller receives the event and identifies 505 it as a ‘low battery’ event. The originating port is then identified 510 and an alert is generated to maintenance personnel to correct the situation.

Yet another potential function is checking the presence and communication ability of a node. Two options are available, the first being that the node sends periodically a signal indicating it is working and capable of communicating with the controller. The second option involves the controller issuing a ‘polling’ communication to a node on a periodic basis, and the node responds, sometimes with status information. Both options are colloquially known as a ‘heartbeat’, and the reception of heartbeat communication from a node is detected 520. Once the node is identified 525 a relevant timer is reset 530, either by resetting the timer physically or by flagging the fact that the node provided heartbeat within the preset period. If a node is silent for a longer than the preset period the node is assumed to be inoperative and maintenance personnel are alerted to facilitated identification of the problem source and of correction thereof.

Context information may be provided to the controller. By way of example temperature, pressure in the fire suppressant supply, arrival or departure of certain goods or personnel, operations of scales and gates, and the like may be communicated to the controller. Such event may come from sensors, entered manually, be derived from video analysis, gate or door information, and the like. Such context information may be used to bring additional rules in condition for activation or prevent activation thereof, or otherwise modify the controller 250 behavior in accordance to specific rules or preprogrammed instructions.

Certain non-fire alerts which may affect the system operation, such as detecting a leak, improper valve closure, inappropriate pressure, port or sensor blockage, and the like may be handled by environmental events 550 which causes the event to be identified 555 and proper action taken 560. Oftentimes such action is to alert personnel to handle the environmental exception, however the handler software may also be configured to take remedial or intermediate steps on its own. By way of example the controller may activate a compressor to compensate for pressure loss in a pilot type system, however if the frequency of pressure replenishment exceeds a certain rate the controller may alert maintenance personnel. Similar to watchdog operation, such environmental events may cause a reset of an offending system, electrical activation of valves, ventilation equipment, and the like. The state that caused the environmental event is commonly flagged 565 until it is resolved.

In certain embodiments one or more of the events handled by the controller are processed or pre-processed in an auxiliary computing facility 250A. By way of example video information may be utilized to detect presence of certain equipment, material, and/or personnel is a specific area. Furthermore video processing may be utilized to detect or verify presence of fire. As video processing requires significant computing resources a second processor may be deployed to off-load the controller 250 from such tasks. In certain embodiments the number of monitored parameters such as sensors and ports is sufficiently large to have parts of the communications of-loaded to a separate processor. By way of example routine tasks such as verifying communication and operation of ports and sensors, checking battery status, UI handling, and the like may be handled by the auxiliary computing facility 250A, and only fire events be handled by the controller 250. Auxiliary computing facility 250A may optionally be remote to the protected volume.

In some embodiments graphical User Interface (UI) structure is utilized for setting rules, determine the topology of a structure and the relative location of ports and sensors therein, the capabilities of ports and sensors, define regions, and set other parameters specific to each particular installations. UI may similarly be used to inquire regarding system status, set up maintenance and remedial operations, disable and enable certain functions, and the like. The construction of a user interface is well known in the art, may be embodied in numerous ways familiar to the skilled artisan, and would not be discussed further in these specifications.

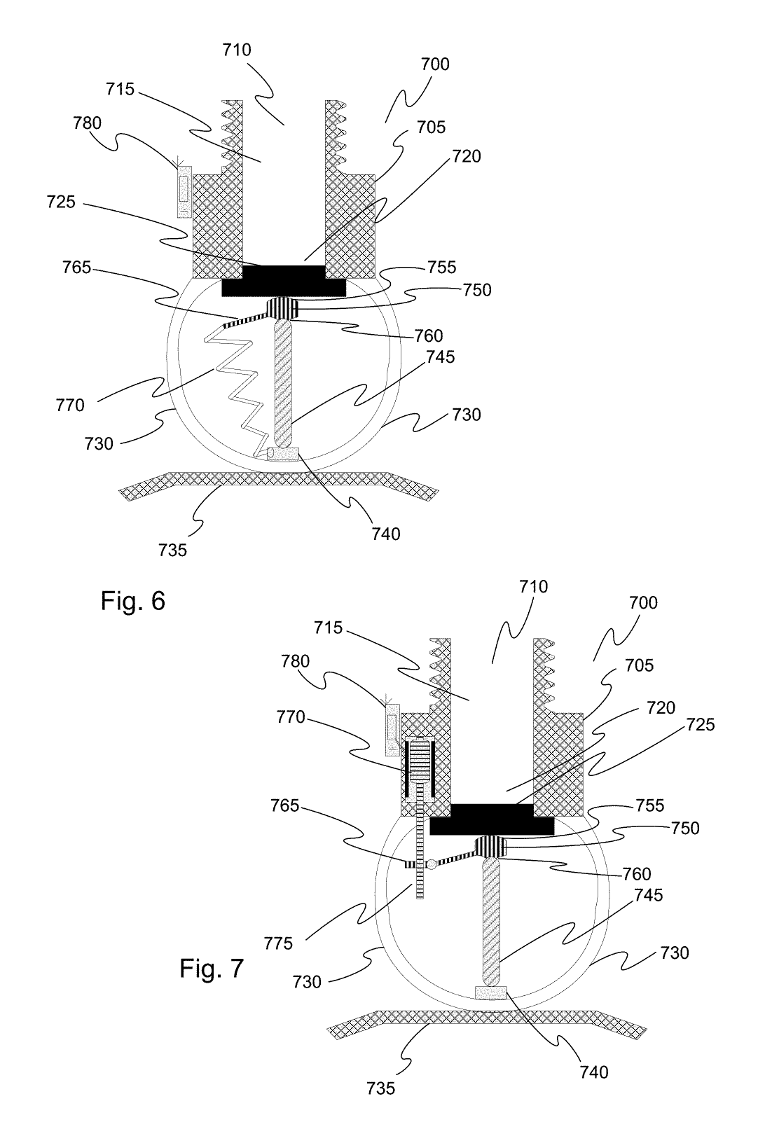

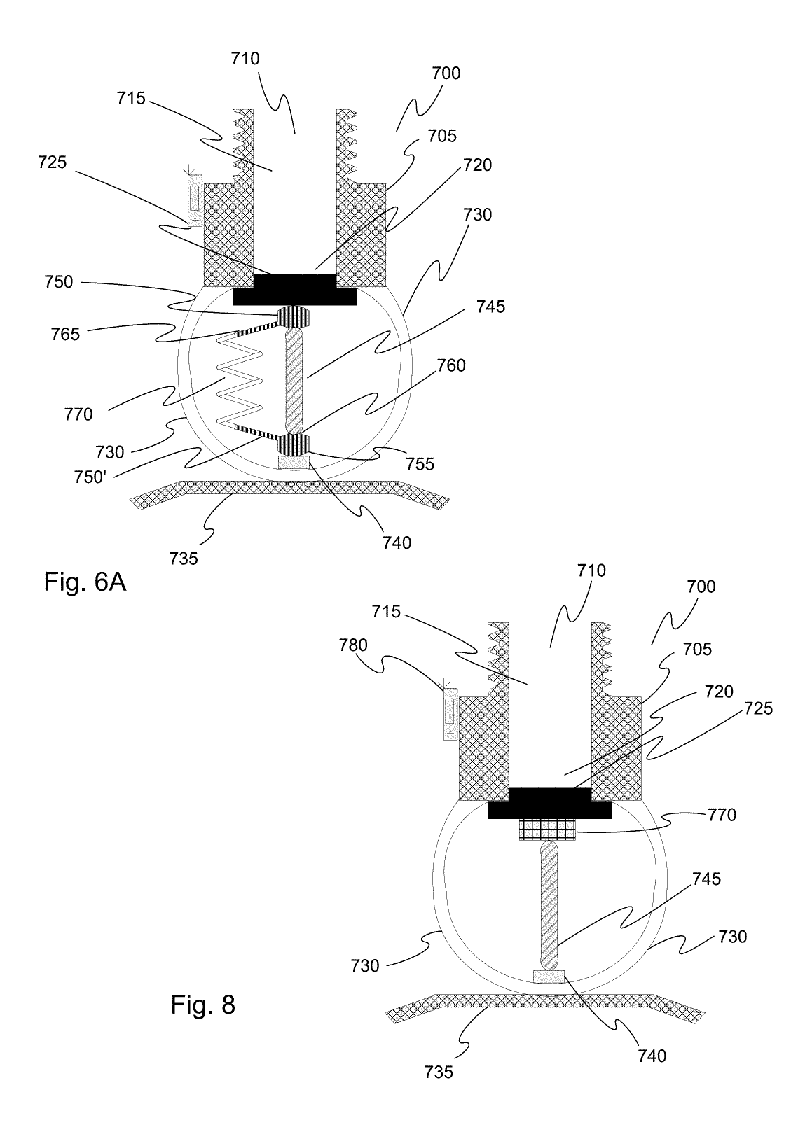

FIGS. 6 and 7 depicts exemplary embodiments of a remotely activatable, individually addressable sprinkler which may optionally be utilized in a fire containment system in accordance with the present invention. The sprinklers are drawn in simplified form which should not be considered as more than simplified examples purely for facilitating understanding of this aspect of the invention.

FIG. 6 depicts a sprinkler 700 having a body 705 with an inlet 710 in fluid coupling with an outlet 720 via an internal fluid pathway 715 through the body 705. Suspension arms 730 depend from the sprinkler body and support a deflector 735. A hub 740 is optionally disposed opposite the outlet 720. While in standby state, the sprinkler outlet is capped by closure element 725, which is held in place by a trigger which may be activated electrically. If desired the trigger may also be activated by an optional heat sensitive trigger mechanism, which may operate independently of the electrical activation mechanism. In some embodiments the electrical and heat sensitive activation mechanisms of the sprinkler cooperate, as seen for example in FIGS. 6 and 7.

The heat sensitive trigger depicted in FIGS. 6 and 7 is based on a frangible bulb mechanism. A glass vial (the Bulb) contains a fluid, the fluid and the vial construction are selected such that when exposed to a predetermined temperature the glass vial brakes. When the vial brakes and pressure is applied to the closure element 725 from the fluid path, the plug would be dislodged and water would be free to exit the outlet, hit the deflector and would be sprayed to douse a fire. The heat sensitive trigger mechanism may also be based on any of a plurality of mechanism types utilizing fusible element, or any other common fire sprinkler activation method.

The electrically activated portion of the mechanism may take various shapes. The sprinkler has a port controller 780. The port controller is capable at least of receiving sprinkler activation command from the controller, and act thereupon to activate an actuator. If the port is a sprinkler and the port controller is also capable of detecting sprinkler activation by the heat sensitive trigger the sprinkler may act as an activation reporting sprinkler. Such activation reporting sprinkler may then act as a sensor for sensing fire events.

In certain application the closure element 725 may be held by a pin or a ball and the electrical actuator such as an electromagnet or motor, acts to remove, or allow the removal, of the pin or ball. In other embodiments the actuator may provide electric energy to heat the heat sensitive element. In other embodiments the actuator may be used to drive a piercing element into the frangible bulb or a mechanical link in the heat sensitive mechanism holding the closure in place. Trap mechanisms using mechanical advantage may also be actuated by the actuator, and numerous embodiments will be clear to the skilled person depending on the structure of the trap mechanism. In certain embodiments the actuator may be an electrical valve directing fluid pressure to dislodge a stop and activate the sprinkler. Generally any desired electrical activation mechanism may be utilized to addressably activate a port such as a sprinkler for the system disclosed above.

In the embodiments depicted in FIGS. 6 and 7 a frangible bulb 745 is utilized as the heat sensitive mechanism, which will activate the port in response to heat irrespective of electrical activation. The frangible link forms a portion of a stud disposed between the closure 725 and the hub 740, or similar support structure supported to the valve body 705, such as support arms 730. The stud further comprises at least one displaceable element 750. The displaceable element is disposed such that its movement beyond a certain range would cause dislodgement of the stud, thus allowing the closure to stop sealing the sprinkler outlet.

The displaceable elements 750 comprises a convex surface 755 contacting the closure 725 in one point of the convex surface 755 and an having a detent 760 on the opposing surface. One end of the frangible bulb 745 is disposed in the detent of displaceable element 750 while the other end of the frangible link is supported on the hub 740. The frangible bulb 745 together with the displaceable elements 750 form the stud which holds the closure against the sprinkler outlet. Displaceable element 750 has an arm 765, which provides mechanical advantage. An actuator 770 controlled by port controller 780 applies a pulling force to arm 765 when commanded. In the depicted embodiment the actuator comprises a Shaped Memory Alloy (SMA) device or a Negative Thermal Expansion (NTE) device, which is anchored to the sprinkler at any convenient point on one end thereof, and the arm 765 on its other end. When heated by an electrical current the SMA actuator applies the required force to dislodge the stud and allow closure 725 to open.

Numerous alternative embodiments of electrical activation mechanisms are envisioned. By way of example, as shown in FIG. 7 the actuator 770 may comprise a motor driving the arm 765 by a threaded rod 775. Electromagnetic, thermal, piezoelectric, and the like actuators may be utilized to apply force to dislodge the displaceable element 750. Optionally, as shown in FIG. 6A two displaceable elements 750 may be utilized, to ease activation. Equivalently, the displaceable element may be disposed on the opposite side of the frangible bulb (not shown). Any of the above mentioned actuators 770 may be utilized to operate on a displaceable element 750 disposed on the opposite end of the frangible bulb 745, or on two displaceable elements 750 and 750′ with simple variations of the activation mechanism. FIG. 6B depicts an embodiment of an electrically activated sprinkler where the closure element is held during standby state by at least one stopper, embodied in the depicted embodiments as ball 640 disposed partially within a groove in closure element 725. The ball is supported by the body and is maintained in place by a plunger 642 which is movable within a cavity. An actuator 646 such as electromagnet or motor is coupled magnetically or mechanically to the plunger 642, and is operative to displace the plunger sufficiently to allow the ball to retract from the closure element grove. In the depicted embodiment the actuator 646 is an electromagnet and the plunger 642 is ferromagnetic. Thus, when the actuator displaces the plunger the ball is pushed by the fluid pressure acting on the closure element, and the closure element is opens the sprinkler allowing fluid flow from its inlet to the outlet. FIG. 6B depicts an embodiment without a heat sensitive trigger mechanism merely to indicate the optional nature of such mechanism in any of the remotely activated sprinklers, and such mechanism may be added to the embodiment of FIG. 6B as well.

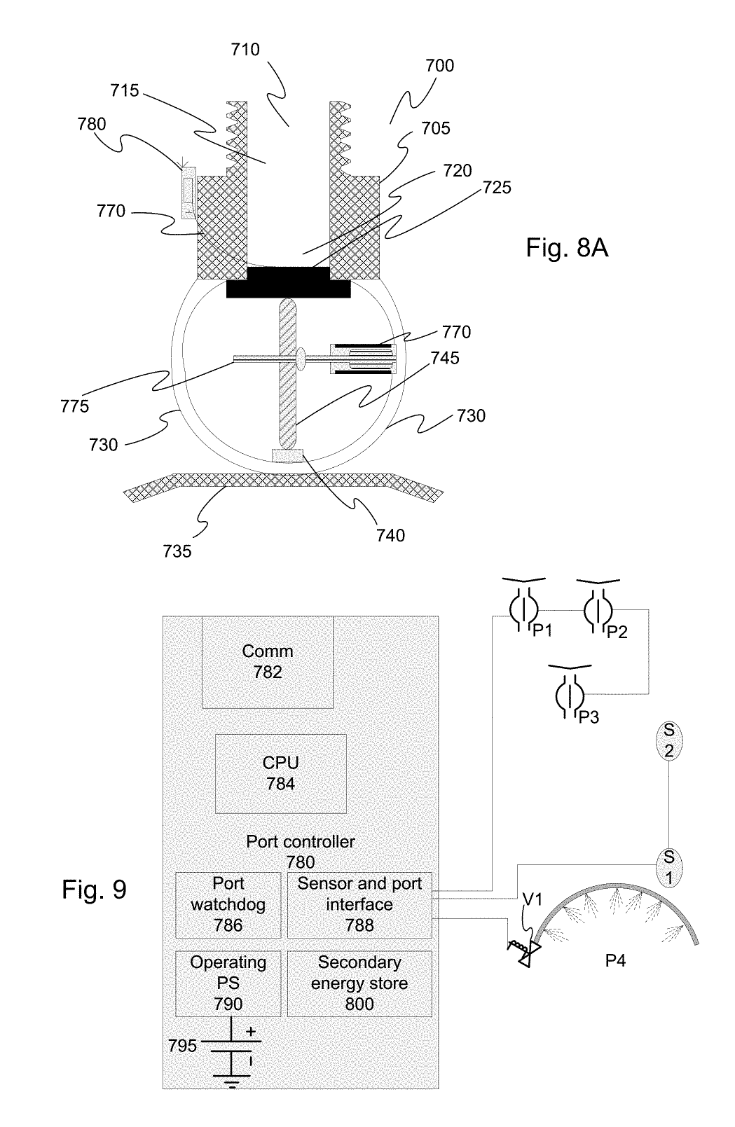

FIG. 8 depicts a sprinkler embodiment with an actuator 770 acting directly on the frangible bulb 745. The actuator may be piezoelectric and either activate sufficient pressure to break the bulb 745, or apply vibrations to the bulb at a frequency appropriate to cause its breakage or dislocation. Another actuator type may apply local heat to a portion of the bulb 745 causing it to fracture. In yet another alternative a motor or solenoid based actuator drives a threaded rod or a screw to dislodge or break the bulb 745 and release the closure element 725, and such embodiment is depicted in FIG. 8A. In light of the present disclosure the skilled in the art would recognize numerous variations of mechanism to efficiently, and preferably using low amounts of energy, to allow opening of closure element 725 in response to a command from port controller 780.

Notably port controller 780 is optional, but highly desirable. In an embodiment which does not use the port controller the sprinkler actuator may be directly coupled to the system controller 250, or a surrogate system thereof, by individual wires. However even in systems which utilize wires to control the various ports, a shared wire bus is preferred to individual wires routed to each port, both for simplicity and efficiency, and thus a port controller is expected to be installed in most installations of systems in accordance with the invention. Clearly, the nature of a port controller depends on the nature of the port itself. Shared bus wires may carry both power and information.

An exemplary embodiment of a port controller 780 for a sprinkler type port is described below. A simplified block diagram of a port controller is depicted by block 780′ in FIG. 9. While FIG. 9 depicts a single port controller controlling a plurality of ports and sensors, the structure of an exemplary individual port controller is sufficiently similar and thus it may be used for a single port application. The port controller may utilize only external power, but preferably comprises an energy store such as a battery 795, either as the sole energy source for its operation, or as a backup to external power. Optionally a port controller may sense the status of such energy store and communicates certain conditions to the system controller either autonomously or in response to a query. A power supply circuitry 790 is provided to provide power conditioning, battery monitoring, battery charging, and secondary energy store handling, as and if applicable. By way of example the power supply circuitry may handle voltage boost functionality to charge a secondary energy store 800, and to supply reduced voltage that may be required for CPU 784 or other circuitry operation. The power supply may condition incoming external power if applicable. The power supply 790 may also care for battery 795 charging if such charging is appropriate and if an energy source for charging is available. In certain embodiments the power supply 790 also monitors the state of battery 795 and communicates it to the CPU 784, which in turns communicates low energy or similar status information to the system controller 250 as needed.

It is further noted that power may be supplied to a plurality of ports from a central power supply remote to the port and/or port controller, and each port controller may individually contain the backup power or the backup power may reside in a centralized location.

The port controller 780 Central Processing Unit (CPU) 784, or the communications module 782 is capable of recognizing commands and queries addressed to itself. Each port controller is therefore addressable, preferably by an address unique at least within the system. The port controller communication link interface 784 may be constructed to handle wired and/or wireless communication, and preferably have a plurality of communication options, such as multiple frequencies, wired AND wireless communications capability, a plurality of wired communications interfaces, optical and acoustic communication links, power line communication links, pipe based communications link, and the like, to provide flexibility and/or communication redundancy.

The port controller CPU is capable of responding to queries and/or initiating communications such as sending event notification directed to the system controller 250. The port controller CPU and additional circuitry may be embodied by any type of logic, such as, by way of example a microprocessor, an ASIC, programmable logic, and the like.

In certain embodiments the port controller 780 contains, or coupled to, a sensor for sensing a fire. The sensor may be disposed within the port or in its immediate vicinity, or may be disposed at some distance from the port, but would commonly be sufficiently close as to sense information relating to the vicinity of the port. Sensors may be of any desired type, such as a heat sensor, a smoke sensor, a gas sensor, a combustion gas sensor, and the like. The sensor may have be coupled via the sensor and port interface 788 or may have its own dedicated interface. By way of example many microcontrollers contain an embedded Analog to Digital (A/D) capability which may be utilized to read the status of many sensor types.

Optionally, the port controller may activate the sprinkler in response to a sensor input indicating the presence of fire. In certain embodiments sensors may not have an independent heat sensitive triggering mechanism. By way of example the port series P4 may be a pipe having a group of open nozzles directed at an object or a zone to be protected. When sensor S1 receives information about a fire in that zone, the port controller 780 can optionally activate the latching solenoid valve V1 and thus activate port P4. Even with a sprinkler having a thermal triggering mechanism, activation by the port controller in response to sensor fire detection may be faster than the activation of traditional sprinklers, due to faster response of the electronic sensor.

In certain embodiments the port controller is also capable of sensing the status of closure member 725, and optionally the closure member status may be considered as an independent sensor, such that an open closure is considered as sensed and detected fire. Optionally the port controller may also be coupled to pressure sensors (not shown) to sense water pressure available for the port, and to generate events alerting the system controller 250 if the pressure is outside predetermined parameters.

As described supra the port controller may be required to respond to a ‘watchdog’ query from the system controller or from a watchdog controller system. Such response may comprise a simple acknowledgement or an extend status such as communicating pressure, temperature, and the like. Optionally the port controller may be equipped with a local watchdog function 786. Such function may be embedded in the CPU 784 or may comprise separate hardware.

Clearly the main function of a port controller 780 is to activate the sprinkler or other ports under its control either in response to a local fire detection, or in response to a command from the system controller 250. Indeed in certain embodiment this is the only function performed by the port controller 780 besides receiving communications. The sprinkler/port activation action is in many cases the most energy consuming amongst all functions performed by the port controller. Thus optionally a boosting arrangement may be utilized where energy from low level energy store such as the battery 795 is converted and stored in a secondary energy store 800 such a capacitor or high voltage battery and the like, wherein the energy stored in the secondary energy store 800 is utilized for port activation. By way of example a voltage boost may be performed by the power supply 790, and a high voltage capacitor may be charged and maintained at high energy level, and such capacitor may be discharged when activation of actuator 770 is required, providing both high voltage and/or high current, as required. Proper sizing of the backup power battery may be utilized to provide sufficient power.

The port controller 780 also has the required hardware 788 and/or software as required to activate actuator 770.

The logic 784 required for such port controller is readily available in many microcontrollers available today and the skilled person will readily recognize how to program such microcontroller in light of the teaching provided herein. Such microcontrollers may operate in reduced power mode, such that their power consumption is sufficiently low to make battery based operation feasible.

A single port controller may be utilized to control a plurality of ports. By way of example port controller 780 may be coupled to a plurality of sprinklers or other ports and combinations thereof, as shown in FIG. 9. If for example a command is received by the communication module 782 and identified by the CPU 784 to activate sprinkler ports P1, P2, and P3, CPU 784 utilizes the sensor and port interface 788 to send sufficient energy to those ports. Similarly, port P4 may be activated by operating solenoid valve V1, which is preferably a latching type solenoid and thus does not require more than a short activation pulse. Sensors S1 and S2 may be coupled by individual wires or by a bus type network as shown.

A port may be a single exit point for fire suppressant which at least may be activated by the controller. However a self-activated port such as a sprinkler or another self-activated fire suppression device is considered a controlled port if it is capable of also being activated by the controller. The port thus may be a nozzle, a sprinkler, and the like, however in certain embodiments a port may also be a set of nozzles such as P4, which may discharge fire suppressant in a manner which is controllable by the controller, however a port comprising of several such nozzles is made of a relatively small section of the distribution system and to a relatively small number of fire suppressant exit point relative to the number of exit points in the distribution system as a whole. Thus by way of example such a port comprises a short length of pipe with a small number of nozzles, where the pipe is coupled to the distribution system via a valve controlled by the controller. In certain embodiments the number of suppressant exit points in such a port may reach 25% of the total exit points in the system, but more commonly it is less than 10%, and in most systems utilizing such ports the port exit points constitutes less than 5% and more commonly less than 1% of the total exit points in the system.

In certain embodiments the port may be independent of the main distribution system 2 and may even utilize different type of fire suppressant, as shown for example by fire suppressant store 259 and port 257. In such cases an independent sensor 238 may optionally be utilized.

As discussed above in certain embodiments the sensor may be a sprinkler which acts as a port but its activation is sensed and conveyed to the controller. Notably a sprinkler may be equipped with a local sensor capable of autonomously activating a sprinkler or other type of port for releasing fire suppressant in the local region, and in these specifications such autonomous sprinkler is considered to be activated, and a fire event occurrence, when such autonomous release occurs.

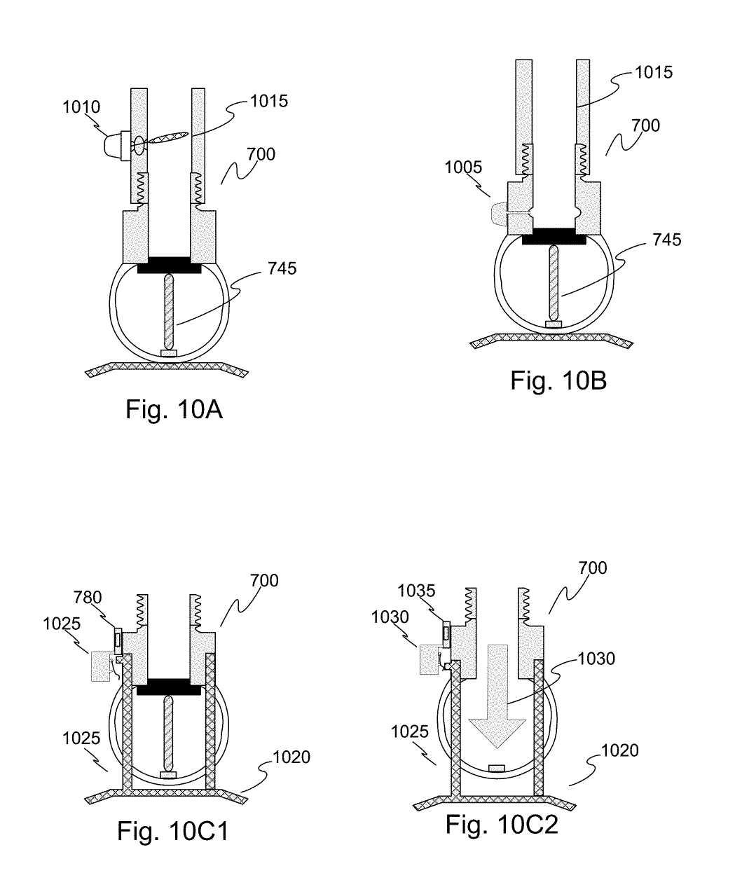

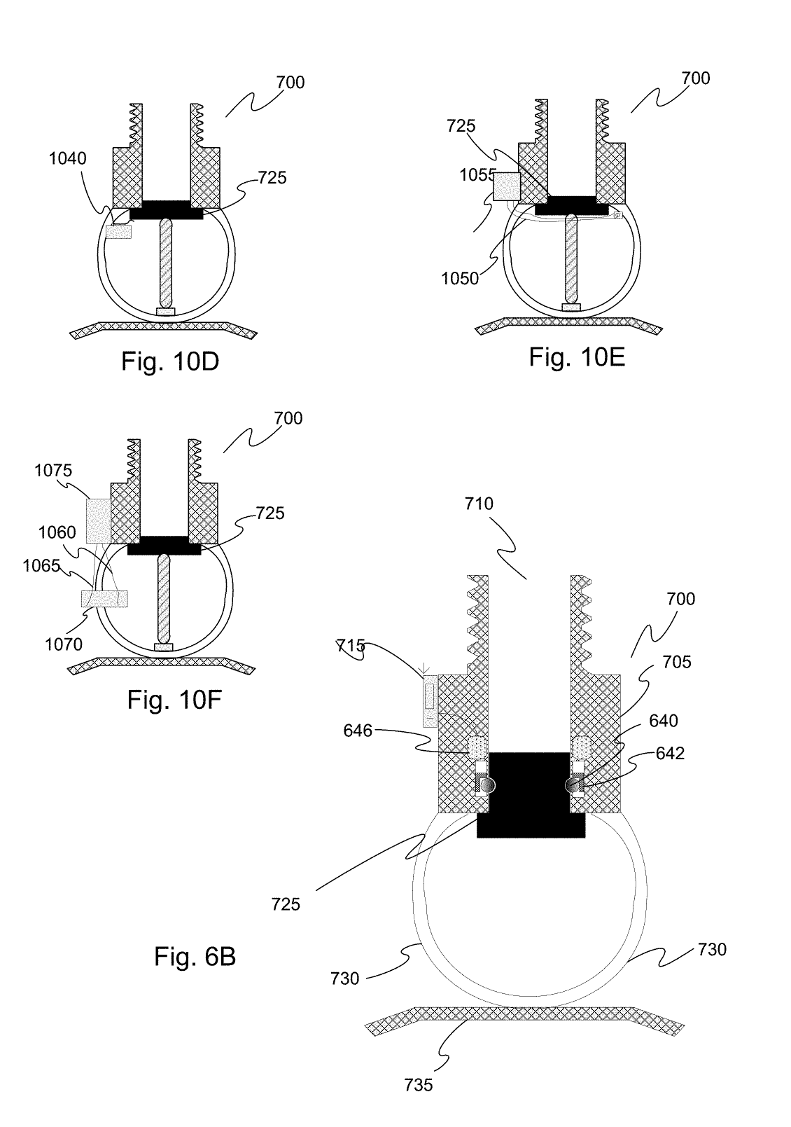

An aspect of the invention comprises activation reporting sprinklers. FIGS. 10A-10F depict exemplary embodiments of activation reporting sprinklers. Such sprinklers incorporate a sprinkler activation monitor operative to detect sprinkler activation, and communicate the activation to a controller or any monitoring device. Such sprinkler activation is considered a fire detection event, and may be communicated to the controller by wired or wireless transmission link. Optionally the communication of the sprinkler activation is carried out via one or more intermediate devices, which in certain embodiments include other sprinklers, communication bridges, and the like. Communicating such sprinkler activation may also occur utilizing network technology, or any desired communication technology, including individual wires. It is important to realize that most sprinkler type may be made to be activation reporting sprinkler by combining a sprinkler of the desired type with a sprinkler activation monitor. An activation reporting sprinkler may also be any remotely controlled, electrically activated and/or addressable sprinklers. In certain electrically activated sprinklers the port controller is already aware of the activation, however in certain embodiment the sprinkler incorporates an electrical activator, a non-electrical triggering device, and a sprinkler activation monitor, and thus the sprinklers in other aspects of the invention may optionally be made activation reporting sprinklers by adding the activation monitoring device. Such embodiments make the sprinkler capable of monitoring its own activation and therefore act as an individual fire sensor. However, the activator is optional and is not mandated to make a sprinkler an activation reporting type.

In certain embodiments of dry type sprinkler systems an activation reporting sprinkler may be utilized to electrically activate a master control valve 10A for introducing fire suppressant to a sprinkler distribution system. Such electrical activation of the master control valve may significantly accelerate the response time of the dry type sprinkler system. Activation of the control valve may be caused via the controller, or simply by connecting a plurality of activation reporting sprinklers to appropriate electrical valve directly or via a simple logic/switching device. By way of example a plurality of activation reporting sprinklers each having a switch may be electrically wired in series or in parallel. If the switches are normally closed type the they are connected in series and if they are normally open the switches are connected in parallel. In parallel arrangement the activation of any switch may be utilized to directly activate an electrical valve, while a series connection would cause disconnection of the serial wire and cause an open circuit which may be detected by simple logic or even relay type arrangement prior to activation of the electrical valve. The electrical valve may directly affect the opening of the control valve or may cause a hydraulic release, such as venting a control chamber, and the like.

An activation reporting sprinkler may also be used by logic to identify the region of the protected volume where the sprinkler has been activated and to localize firefighting activities appropriate to the region. Various method of electro-hydraulic activations are known, and/or will be clear to the skilled in the art. Activation reporting sprinklers will also allow automatic and/or advisory isolation specific regions within the protected volume. It is thus seen that an activation reporting sprinkler is beneficial in both fire containment systems, and other firefighting sprinkler systems. It is further noted that in most systems, activation reporting sprinkler may co-exist with common sprinkler type activation systems, such as actuators for master control valves 10A of hydraulic type, or actuation of a differential master control valve 10A by pilot pressure present in the distribution system.

In FIG. 10A the sprinkler activation monitor comprises a flow sensor 1010 for detecting fluid flow in a localized conduit leading to the sprinkler 700, or in the sensor body itself. The detection of flow is considered a sprinkler activation. Such flow may be detected in a wet type system by the flow of the primary firefighting fluid, or in a pilot type dry system by the flow of pilot fluid, which may be liquid or gaseous. A flow detector may comprise a movable surface 1015 exposed to fluid flow before the sprinkler which may also be disposed in the sprinkler body, or after the sprinkler outlet. The movement of the movable surface to and/or from a predetermined state is considered a sprinkler activation event.

FIG. 10B depicts an embodiment of an activation reporting sprinkler where a pressure sensor 1005 is utilized to sense pressure variation of the fluid in the sensor waterway, and a rapid pressure change is considered a sprinkler activation. However, to avoid false activation signal due to system pressure fluctuation an optional delay is desired in combination with such activation reporting sprinkler. The delay may be implemented locally, in the port controller if used, or in the controller.

FIGS. 10C1 and 10C2 depict an embodiment of an activation reporting sprinkler 700 utilizing the sprinkler deflector 1020 as a sprinkler activation mechanism. FIG. 10C1 depicts the sprinkler in standby position and FIG. 10C2 depicts the sprinkler after activation. Sprinkler deflectors are common however the sprinkler deflector 735 is suspended from at least one suspension arm 1025 which allows displacement of the deflector. A switch 1030 is disposed to sense deflection of the deflector. The deflector may be maintain in its position by any desired retention mechanism, such as friction, frangible piece, a spring and the like.

FIG. 10C2 depicts the sprinkler of FIG. 10C1 in activated state where the heat trigger 745 (While in other depictions a frangible link is utilized as the heat trigger mechanism 745, however any heat trigger may be utilized) has activated, and allowed the closure element 725 to open. The arrow indicates fire suppressant flow from the sprinkler. As the deflector 735 is downstream from the sprinkler outlet 720, the stream of fire suppressant urges the deflector 735 away from the sprinkler outlet and causes displacement thereof. The suspension arm 1025 activates the switch 1030, indicating a sprinkler activation.

While in the depicted embodiment the deflection is linear, the skilled in the art would readily understand the other displacement may be utilized, such as radial displacement.

FIGS. 10D and 10E depict activation reporting sprinklers having a sprinkler activation monitor which comprises a closure element status monitor. In FIG. 10D a closure element status monitor comprises a switch 1040 which changes state if the closure element 725 is displaced from closed to open state, as will be the case if the heat trigger activates. The switch 1040 may be in actuated directly by the closure element or by an intermediate member or members, such as arms coupled to the switch or the sprinkler (not shown), and the like. Optionally the closure element itself forms a portion of the switch (Not shown).

In FIG. 10E the closure element monitor comprises a wire 1050 disposed in front of, or coupled to, the closure element 725, the wire being sufficiently thin to be torn in response to opening of the closure element. Circuitry 1055 coupled to the 1050 wire is configured to detect tearing of the wire. Monitoring the wire integrity can be done by sensing electrical continuity therethrough.

In some embodiments the sprinkler activation monitor comprises a fluid presence device disposed to receive fluid from the sprinkler after the sprinkler transitions to an open state, and the detection of fluid is considered a sprinkler activation event. FIG. 10F depicts an example of such fluid presence detector comprising two or more electrodes 1060, 1065 disposed in a basin 1070 which would be flooded by the firefighting or pilot fluid of the activated sprinkler 700. The resistance between the wires would change as a result of fluid presence therebetween. The resistance change is detected by circuitry 1075 and communicated to the controller. Similarly a fluid presence detector may comprise two parallel plates acting as a capacitor, and disposed such that fluid form an activated sprinkler would be introduced into a space therebetween, which will result in detectable capacitance change, or even short circuiting of the capacitor (not shown).

In some embodiment the sprinkler activation monitor may comprise a switch disposed to against a triggering device or a portion thereof, and operational to switch states responsive to activation of the triggering device. FIGS. 7 and 8A are examples where the switch (not shown) may be actuated by the activation device.

In some firefighting or fire containment system embodiments direct wiring is established between the controller and the switch in any type of activation reporting sprinkler. The depicted embodiment utilizes an optional communication module 1035, which may be utilized to encode and communicate the sprinkler activation to a controller. The communication module may communicate the information by wire or wirelessly. Any of the sprinklers depicted in these specifications may utilize an optional communication module, and such communication may be incorporate with the port controller if one is utilized. Piping in the distribution system may optionally be used as a conductor.

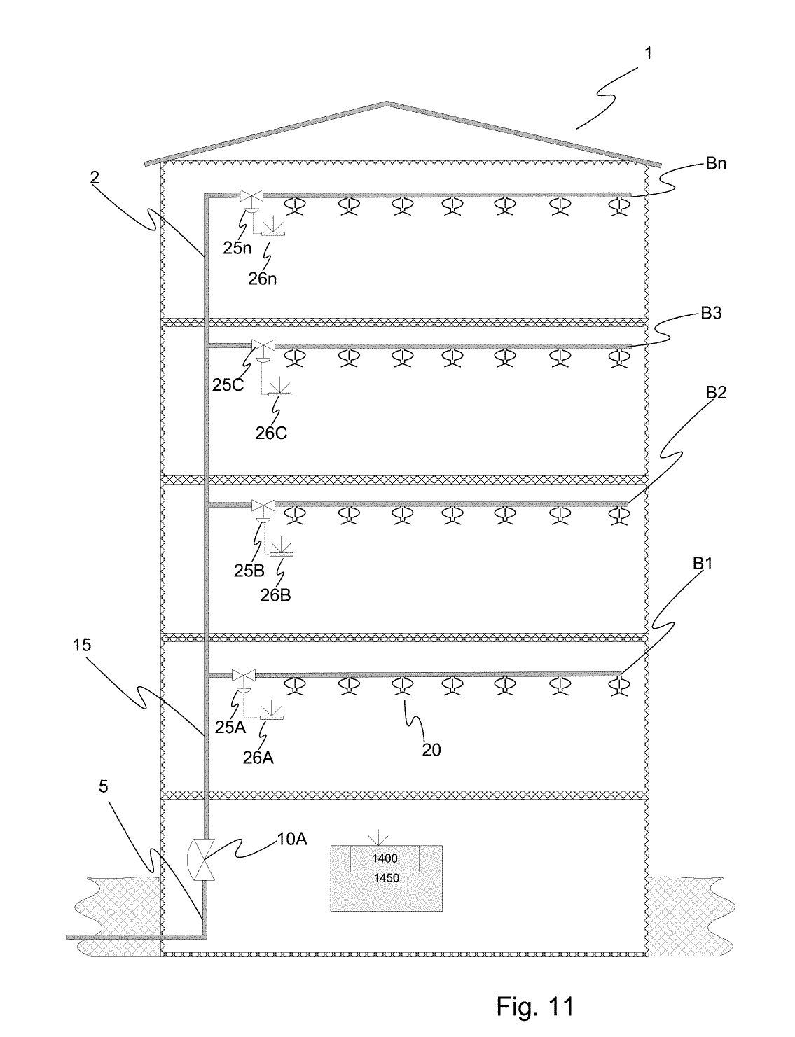

Yet another aspect of the present invention is directed at reducing the costs involved in installing and maintaining firefighting and fire containment systems. Somewhat similar to the system shown in FIG. 1, FIG. 11 is simplified but depicts a structure 1 which is protected by a sprinkler system 2, pressurized fire suppressant is supplied from a source such as municipal water mains, a tank, and the like, and arrive at the system by a mains pipes 5. The mains supply pipe is coupled to a master control valve arrangement 10. As stated elsewhere the master control valve 10 may be a simple check valve is certain types of wet type systems or may be more elaborate such as alarm valve, a differential valve in dry-pipe type systems, hydraulic valves coupled to actuators, and other optional trim in certain types of dry systems, and the like. Commonly, a controller and/or a fire alarm control panel (FACP hereinafter), or a combination thereof is coupled to the various elements of the system. For brevity the controller and/or FACP and or the combinations thereof shall be referred to hereinafter merely as a ‘panel’.

The master valve 10 is coupled to the distribution system which includes a main distribution pipe commonly known as a riser 15. In many firefighting systems branches (B1, B2, . . . Bn) are connected to the ‘riser’. A plurality of sprinklers 20 are coupled to the branches. Branch valving arrangements (25A, 25B, . . . 25n) are utilized for controlling the flow into a respective branch (B1, B2, B3, . . . Bn). However in this embodiment at least one of the branches is coupled to a wireless branch terminal (26A, 26B, 26C, . . . 26n) the terminal acting as a wireless link relaying information about the branch status, such as alarm, status of one or more valves, pressure information, and the like to a panel concentrator 1400 which may be incorporated within the panel 1450, or external thereto. The combination of one or more branch terminals and the panel concentrator establishes a communication link therebetween and allow significant savings in installation and configuration of a firefighting and/or fire containment system, as well as offering greater control and localization, while maintaining all the requirements of a fire alarm system, including supervisory and backup functions.

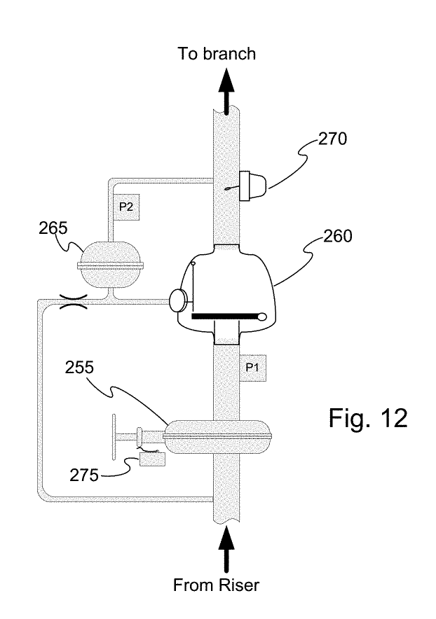

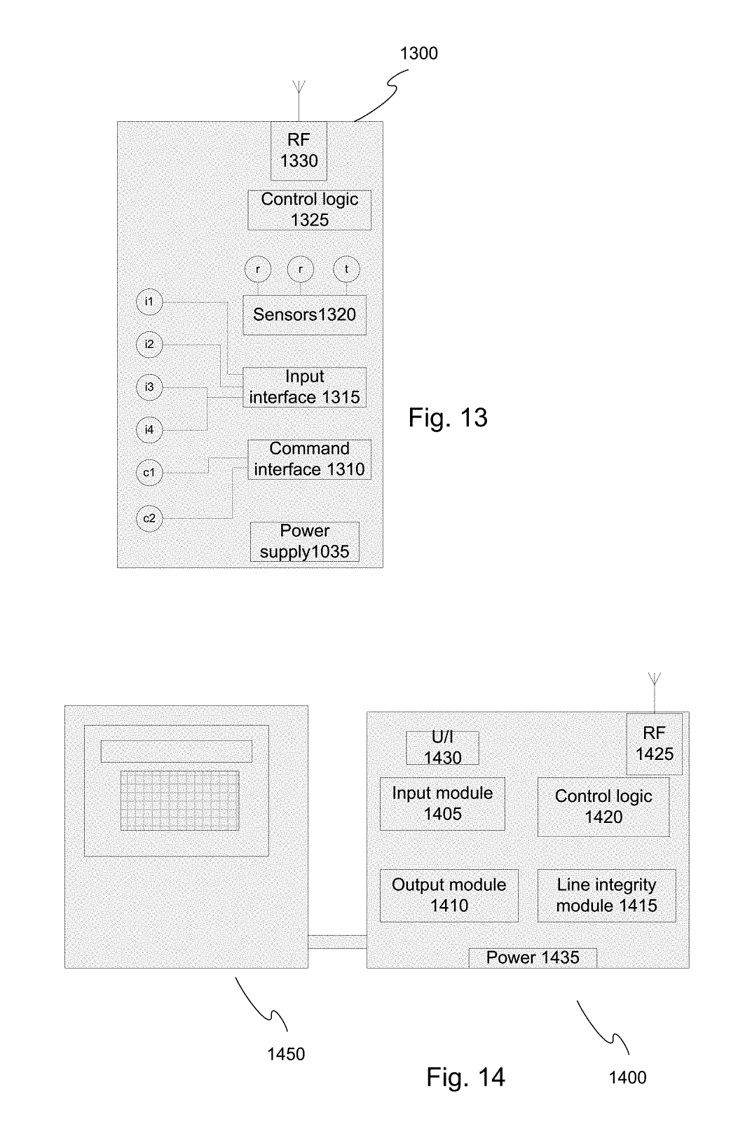

FIG. 12 depicts a simplified diagram of an exemplary branch valving arrangement 25. The arrangement comprises a shutoff valve 255, a hydraulic valve 260 coupled to an actuator 265, and a flow switch 270. In some implementations some branches are ‘wet’ and some are ‘dry’ type systems. In dry branch a control valve 260 is also required to prevent water in the riser from entering the dry branch until fire is detected, and hydraulic valve 260 is one example of a dry type system control valve, with differential type valves being another common example. Hydraulic valve 260 is activated by an actuator 265. Several types of actuators are known in the art, as well as numerous methods of controlling of such actuator, to cause release of fluid from the riser to the dry branch in response to fire detection within the branch, and thus shall not be discussed or shown herein. A flow detector 270 or some other type of an alarm sensor is disposed to detect flow in the branch, which indicates a fire event.

In many implementations the shutoff valve have a switch 275 coupled thereto to indicate if the valve is open or closed. The flow detector embodies in many embodiment yet another switch. In certain embodiments pressure is sensed by pressure sensors such P1 to measure inlet pressure, and in pilot type systems the pilot pressure is also commonly monitored by the like of pressure sensor P2. Pressure sensors P1 and P2 may be simple pressure switches, or comprise pressure transducers that provide analog or digital information to the panel. It is thus seen that in a common branch valving arrangement several switches and optionally sensors require wiring between the branch piping arrangement and a controller or a fire alarm system control panel. Laying out these wires and properly connecting them is time consuming and costly. Several wiring schemes are known in the art, such as by way of example class A style D, which is a common wiring method for such switches. This wiring system enables checking the wiring integrity in addition to detecting the status of the switches. However the current wiring schemes oftentimes lump several switches in a group without capacity to differentiate which of the group switches caused the alarm or warning.

To alleviate those disadvantages an aspect of the invention provides a wireless link between at least one branch valving system and a panel.

The wireless link comprises a branch terminal 1300 and a panel concentrator 1400. The branch terminal 1300 comprises a power supply 1305, optionally with a backup system such as a battery, battery charger, surge protection, and the like. The branch terminal further comprises an input interface 1315. The input interface is electrically coupled to a plurality of terminals i1-i4 which during installation are connected to switches of concern in the branch valving arrangement 25, such as the flow detection switch 270, and/or shutoff valve status switch 275. Optionally the input interface is also capable of handling analog and/or digital inputs, such as those provided by pressure sensors P1 and P2, and are coupled to such sensor if used. Optionally the branch terminal further comprise a command interface 1310 coupled to a plurality of terminals c1-c2, for activation of local devices such as a compressor for pilot systems, alarms, and optionally activation devices for electrically activating valves such as control valve 260. During installation the command terminals are coupled to the respective devices. Further optionally a sensors interface 1320 may be provided, which is coupled to one or more environmental sensor r1, s1, t1, such as temperature, humidity, noise, smoke detector, ionization detector, and the like. The branch terminal operation is controlled by terminal branch control logic 1325. The branch terminal also has a radio frequency module 1330 for communicating with the panel. The branch terminal 1300 logic may comprise a programmable processor in combination with non-transient memory storing a program accessible by the processor. In some embodiment the control logic, and optionally other modules or portions thereof are embodied in specialized logic such as an Application Specific Integrated Circuit (ASIC), programmable logic, or other circuitry. In some embodiments the branch terminal circuitry includes analog to digital (A/D) circuitry to handle analog input from sensors and transducers. Optionally several of the modules 1310, 1315, 1320 are integrated, optionally with the control logic 1325. Preferably the roles of specific terminals may be determined by software. Furthermore, certain local functions are optionally carried out locally. By way of example in a branch terminal which has a pilot pressure sensor and a compressor or air pump to compensate for drop in the pilot pressure, the branch terminal logic may optionally turn on the compressor to compensate for such a drop, however in some embodiments if the frequency of such drop exceeds a preset level the branch terminal communicates a potential problem indication to the panel or to a separate controller.

FIG. 14 depicts a panel concentrator 1400 in combination with a panel 1450. As discussed above, the panel may be a fire alarm control panel, a firefighting and/or fire containment controller, or a combination thereof. The panel concentrator is shown separate from the panel, but may optionally be integrated therewith. Integration may comprise a common enclosure and optionally common circuitry. As will be cleared to a person skilled in the electronic arts, differing modules may be incorporated and executed by common circuitry.

The panel concentrator communicates with one or more branch terminals via wireless link module 1425. Communication may take place in a hub and spoke topology where each branch terminal communicates directly with the panel concentrator, or communication may be established via intermediate devices such as other branch terminal(s), network bridges and the like.

A panel that has been integrated with a panel concentrator, or been designed to interact with such concentrator at data interchange levels shall be referred to herein as an integrated panel. In contrast a panel that is not integrated and that is designed to interact solely with common switches, alarms, and the like, shall be referred to herein as a legacy panel. It is noted again that the term panel refers to a fire alarm panel and/or a controller and to any combination thereof.

The panel controller has an input module 1405 which interfaces with one or more of the input ports of the panel, and an output module which interfaces with one or more of the output ports of the panel. In integrated panels the ports and any other components may be conceptual, while in legacy panels the ports are commonly terminals that accept physical wiring.

In some embodiments utilizing legacy panels the panel concentrator has its own power supply and/or backup power 1435, however in other embodiments the panel concentrator receives power from the panel or vice versa.

Most legacy panels utilize line termination to verify wire integrity to inputs such as switches and or sensors, as well as to external notifications devices such as alarms. Commonly resistors are utilized at the end of a bus connecting a plurality of switches and the wiring integrity is monitored by measuring current through the wire loop. Lack of current indicates a break in the wire, while a short indicates switch closure.

In order to provide communication integrity between the panel concentrator and the branch terminals the panel concentrator at least monitor periodic transmissions from the respective branch terminal. Such periodic transmission is colloquially referred to as a ‘heartbeat’. In embodiments utilizing legacy panel a line integrity module 1415 is provided to simulate the loop termination by providing the required current path with proper resistance to satisfy the panel 1450 line integrity condition, and to also simulate a line disconnect to the panel if communications with a branch terminal is lost by increasing the resistance, or opening the circuit. Such disconnect may be may be achieved by a relay, a transistor, and other switching devices known to the skilled electronic designer. Thus, operationally a branch terminal periodically communicates with the panel concentrator, either autonomously or in a query-response protocol. The line integrity monitor 1415 in the panel concentrator 1400 keeps track of this heartbeat and determines if it is lost. While operating in conjunction with a legacy panel the line integrity module maintains the input line of the panel 1450 associated with the corresponding branch in a state reflecting equivalent status to wired line. Stated differently, for a panel which utilizes line terminating resistor, the panel concentrator maintains predetermined resistance connected to the panel port associated with a branch as long as the heartbeat continues to be received from the respective branch terminal, and opens the circuit when the heartbeat is lost for a predetermined period. Such arrangement allowing the panel to indicate a warning condition. The skilled in the art would recognize that in integrated panels the line integrity module need only to check the heartbeat in order to assert the integrity of the branch terminal, and may communicate any warning directly to the panel logic without requiring changes in resistance, and the like.

In embodiments where bidirectional communications are established, the branch terminal may provide further information, such as local sensors, status, and the like.

In a legacy panel the input module 1405 is connected to respective input ports of the panel, and the input module opens and closes circuits as required, to mirror the status communicated from the respective branch terminal. Similarly, the output module monitors command outputted by the panel are communicated to the respective branch terminal which in turn asserts its own ports, such as by or opening closing a related circuit, and the like. In certain embodiments the control logic 1325 of the branch terminal may provide additional services, such as autonomous monitoring of certain conditions, A/D operations, signal condition, circuit latching, timing functions and the like. Such actions may as well occur in the panel concentrator. However commonly if the panel concentrator is coupled to a legacy panel the combination of the panel concentrator and the branch terminals allows the system to simulate the operation of a legacy wiring of the panel in a transparent manner. In contrast, an integrated panel may benefit from additional functionality offered by the individual addressing of specific system components, from distributed intelligence of the logic, and the like. By way of example, while legacy panel is merely alerted that one branch in the system ad tripped, the integrated panel would know which branch did, and which switch operated, allowing it to take containment action, to better control and direct flow away from non-essential consumers, and the like. Further, if by way of example an activation reporting sprinkler communicates its activation from a ‘dry’ type branch, the panel controller may issue an output command to the respective branch terminal to activate the respective control valve electrically, saving valuable firefighting and/or fire containment time.

Furthermore, the branch terminal may accept information, either by wire or wirelessly from sprinklers and/or other sensors in the branch and relay them to the controller. In systems where remotely controlled, addressable sprinklers are utilized the branch terminal may communicate directly with its respective sprinklers and either relay the information to the panel controller, or act as a local controller, offloading processing from the panel/controller. The branch terminal may act to receive information from the sprinkler or sensor, and/or activate the sprinkler in response to commands from the panel, in accordance to local rule set, or in combination thereof.

The panel concentrator further has a user interface (UI) unit 1430. The user interface unit allows programming and configuring the system. The UI unit may be local, requiring an input and an output device, or remote, utilizing a communication protocol. In certain embodiment the UI unit is responsive to an app operating on a mobile device or on a remote computer. In certain embodiments short range communication only is enabled, requiring physical presence of the programming device in proximity to the panel or panel concentrator. Programming/configuring of the branch terminal may be accomplished in a similar manner by a UI module installed in the terminal, or by commands communicated from the panel concentrator or the integrated panel. In certain embodiments the configuration of the branch terminal is fixed prior to installation and may not be field modified. Commonly however it is desired to be able to pair two stations to establish communications therebetween and to that end configurability is desired.

A branch terminal may be utilized for conveying any type of information to the FACP/controller by coupling it to a proper transducer, even if not immediately utilized for the pipe branch itself. By way of example, individual sprinkler and other sensors may be coupled to the branch terminal, as well as manual activation buttons, and the like.

It is highly desired that any communication occurring between any communicating devices such as any panel, controller, concentrator, sprinkler, and the like would be encrypted, and that protocols utilized for such communications are capable of handling electrically noisy environments, lost packages, interference, and the like. It is desired that if intermediate nodes are used for communications to nodes remote to the panel concentrator proper protocols are selected to allow bypassing of a malfunctioning intermediate node and preferably automatically reconfigure the network to reestablish communications.

Common controller functions such as watchdog timer, interrupt response, memory management, and the like may be integrated to each of the controllers/panels described herein, and into panel concentrators and branch The volume to be protected may be contained within a single structure, distributed over a plurality of structures, or encompass an open area containing items to be protected, or any combination thereof. The structures may, by way of non-limiting example a house, a warehouse, a shop or a cluster of shops, a workshop, a storage facility, a vessel such as a ship or an aircraft, a garage, a parking garage, an office or an office buildings, a cinema, sports arena, or other events oriented structure, a transportation station such as a shipping or airport terminal, a train station, a tunnel, a shelter, a factory or other production facility, a housing complex, and the like.

A fire detection event is assumed when a sensor detects a condition associated with a fire. By way of example a sprinkler may be exposed to temperature exceeding a predetermined limit for a predetermined time, and as a result begin dispersing firefighting fluid onto its surroundings. Notably, the sprinkler heat sensitive element may operate by first communicating to the controller the activation of its fire detector—whether by heat, smoke, ionization, and the like—and as a result the controller commands activation of the sprinkler, or the sprinkler fire detecting element triggers the sprinkler and then the sprinkler senses and communicates the triggering to the system. Both events are considered a fire detection event. Furthermore, in a dry type firefighting system utilizing a pilot piping system separate from the main fire suppressant distribution system a sensor such as a sprinkler in the pilot system may detect the fire, communicate it to the controller, and activates the sprinkler. It is important to understand that the fire detection event is an event programmed into the system design and indicates the presence of an event assumed to be caused by a fire. In case of smoke based fire event detection, the presence of smoke may or may not indicate actual fire, however the event of a triggered smoke alarm is considered a fire event. Similarly, a video sensor indication of the presence of fire is a fire detection event, even in case of inaccurate indication. Manual activation of a fire button is similarly consider fire detection event. As explained above more than a single fire detection event may be required to cause dispersion of fluid from certain portions of the system, thus allowing implementing localized single and double interlock firefighting systems with a single controller.

Controllers FCPA's, branch terminals, panel concentrators, various sensors, sprinklers, and other ports may communicate utilizing any convenient method such as wireless, wired, optical communications, and the like, and using any desired protocol such as TCP, IP, RS-232, RS-485, and the like. The communications may be direct between end nodes, or via one or more intermediate links and/or nodes. Preferably communications between the nodes of the system may be established by more than a single path, for redundancy. By way of example such arrangement may utilize two modes of communication such as wired and wired communication, utilizing different frequencies, and the like. Any kind of data communication link may be utilized and the selection of communication link is a matter of technical choice. By way of example multi-path networks such as Zigbee™, Thread™, Wireless Sensor and Actuator (WSAN™), SPWar networks, and other wired or wireless mesh networks may be utilized as well as more common solutions such as WI-FI and Bluetooth and similar communications. Wired communication solutions range from direct connection to networks such as Ethernet, 1-Wire™, I2C™, SMBus™, IEBus, RS-232, RS-485, power line based transmission, and the like. Preferably, communications between the nodes, such as ports, sensors, any repeaters or routes, and the controller is encrypted to prevent tampering. Such encryption is especially important in a wireless network to prevent inadvertent or malicious interference, while providing fast and reliable service. As described above, more than one communication mode may exist. Wired communication modes may provide operating energy, however energy store device such as a battery, a capacitor, and the like is also desired even when power is externally supplied. In purely wireless system energy store is needed. Optionally the node such as a sensor or a port monitors the status of energy store, and communicates low levels or other deficiencies to the controller which in turn reports it for human intervention such as battery change, and the like. Wireless communication modes, such as the wireless links between the branch terminal and a panel concentrator may similarly utilize any applicable protocol as described above and may combine wired communication with wireless communication. Thus by way of example if a port concentrator and/or a branch terminal are coupled by wire to an intermediate device which in turn uses wireless communication to complete the communication with a second device the link is considered wireless and each of the communicating devices is considered as having wireless communication module therein.

Controllers are known in the art and exist as digital or analog circuitry, commonly in combination with supporting structure such as power supplies, cooling devices, switching aids, and the like. A controller may equivalently comprise a combination of at least one software program and hardware to execute the program, or dedicated hardware, optionally constructed to perform the equivalent of a program. A controller commonly has a plurality of inputs and outputs and reacts to changes in inputs, including potentially time, by changes in output. Activation of a device, apparatus, or component by a controller commonly involves changing the state of one or more output or transmission of data from the controller, and oftentimes includes activation of intermediate devices such as switching aids, transmitting devices, receiving devices, intermediate controllers and the like. Inputs to the controller may include communication links, input devices, sensors, switches, as well as program state, and the like. The processor may monitor the state of such inputs or be interrupted by the occurrence of an input event. Temporal and conditional terms relating to controllers should be construed as indicative that during operation, whether under the control of a program or due to the relevant physical structure, the controller would transition in a prescribed manner if the causal condition occurs. Thus, by way of example a statement such as “the controller would do X when condition Y exists” should be construed as a) the possibility of Y occurring positively exists, b) the occurrence of Y, within the specified conditions, would cause the controller to convert to a state in which the system as a whole or a specified component thereof, would transition to the prescribed state X. Stated differently the structure of the system as a whole is capable of responding to the occurrence of a given condition set in at least the manner described in the specifications in relevant sections to such condition set, and the question of whether such condition occurs is immaterial. Furthermore unless specifically specified, the resulting state or action (X) may occur for differing circumstances without the occurrence of Y. Furthermore, while the occurrence of condition Y is dispositive for causing X, non-occurrence of Y does not imply any state, other than the avoidance of transition to state X due to Y, and no inference should be made otherwise, nor should the state of the controller, the system, or portions thereof be considered in indefinite and/or undetermined state. Thus stating a conditional occurrence of a state such as Y without specifying any action or state which would occur otherwise, should be construed that the controller would continue to perform its function as if Y did not occur.

It is further noted that various aspects of the invention may be combined therebetween and/or with prior art systems and components, and that such combinations are explicitly considered within the scope of the invention. Thus by way of example the invention extends to firefighting systems utilizing any combination of prior art sprinklers and activation reporting sprinklers, and/or any of the remotely controlled sprinklers described herein, and such firefighting system or fire containment system is considered within the scope of the invention. Similarly, a firefighting system which utilizes FACP operating in combination with activation reporting sprinklers and any combination of sprinklers known in the art, and such firefighting or fire containment system is considered within the scope of the invention. Fire containment systems may be combined with firefighting systems such that only a portion of the combined system acts as fire containment system as described herein and the system as a whole is considered to fall under the scope of the present invention. Stated differently a fire containment system which acts to selectively surround a fire according to any of the principles and methods, and which utilize any equipment as described above is considered to fall under the scope of the invention regardless of the fact that certain portions operate merely as common sprinkler systems, utilize any combination of sprinklers optionally including activation reporting sprinklers. Furthermore combinations of firefighting systems and fire containment systems which utilize the branch terminal in combination with panel concentrator fall under the scope of the invention whether or not common wiring systems are utilized in combination therewith. The skilled in the art would readily recognize additional combination of systems and components which may be combined under the scope and spirit of the invention and the invention extends thereto.

Unless otherwise specified, relational terms used in these specifications should be construed to include certain tolerances that the skilled in the art would recognize as providing equivalent functionality. By way of example the term perpendicular is not necessarily limited to 90.0°, but also to any slight variation thereof that the skilled in the art would recognize as providing equivalent functionality for the purposes described for the relevant member or element. Terms such as “about” and “substantially” in the context of configuration relate generally to disposition, location, or configuration that is either exact or sufficiently close to the location, disposition, or configuration of the relevant element to preserve operability of the element within the invention which does not materially modifies the invention. Similarly, unless specifically specified or clear from its context, numerical values should be construed to include certain tolerances that the skilled in the art would recognize as having negligible importance as it does not materially change the operability of the invention.

In these specifications reference is often made to the accompanying drawings which form a part of the disclosure, and in which are shown by way of illustration and not of limitation, exemplary implementations and embodiments. Further, it should be noted that while the description provides various exemplary embodiments, as described below and as illustrated in the drawings, this disclosure is not limited to the implementations described and illustrated herein, but can extend to other embodiments as would be known or as would become known to those skilled in the art. Reference in the specification to “one embodiment”, “this embodiment”, “these embodiments”, “several embodiments”, “selected embodiments” or “some embodiments” means that a particular feature, structure, or characteristic described in connection with the embodiment(s) may be included in one or more implementations, and the appearances of these phrases in various places in the specification are not necessarily all referring to the same embodiment(s). Additionally, in the description, numerous specific details are set forth in order to provide a thorough disclosure, guidance and/or to facilitate understanding of the invention or features thereof. However, it will be apparent to one of ordinary skill in the art that these specific details may not all be needed in each implementation. In certain embodiments, well-known structures, materials, circuits, processes and interfaces have not been described in detail, and/or may be illustrated schematically or in block diagram form, so as to not unnecessarily obscure the disclosure.

For clarity the directional terms such as ‘up’, ‘down’, ‘left’, ‘right’, and descriptive terms such as ‘upper’ and ‘lower’, ‘above’, ‘below’, ‘sideways’, ‘ inward’, ‘outward’, and the like, are applied according to their ordinary and customary meaning, to describe relative disposition, locations, and orientations of various components. When relating to the drawings, such directional and descriptive terms and words relate to the drawings to which reference is made. Notably, the relative positions are descriptive and relative to the above described orientation such as an upright orientation and modifying the orientation would not change the disclosed relative structure.

It will be appreciated that the invention is not limited to what has been described hereinabove merely by way of example. While there have been described what are at present considered to be the preferred embodiments of this invention, it will be obvious to those skilled in the art that various other embodiments, changes, and modifications may be made therein without departing from the spirit or scope of this invention and that it is, therefore, aimed to cover all such changes and modifications as fall within the true spirit and scope of the invention, for which letters patent is applied.

I claim:

1) A fire containment system for protecting a protected volume the system comprising:
a controller;
a fire suppressant distribution system coupled to a fire suppressant supply, the fire suppressant distribution system being at least partially in the protected volume and having a plurality of distribution ports each being associated with at least one region of the protectable volume, the ports being coupled to the controller and capable of being activated thereby for releasing fire suppressant at least into their respective associated region;
a plurality of sensors disposed in the volume, at least a first sensor of the plurality of sensors being associated with a first region of the volume, the first sensor being in data communication with the controller and capable of communicating thereto a condition associated with detection of a fire event;
the controller being adapted to activate a set of ports to disperse fire suppressant in response to detection of fire event by at least the first sensor, the activated set containing at least a first port in a region spatially adjacent the first region.

2) A fire containment system as claimed in claim 1, wherein the activated set contains at least one port in the region associated with the first sensor.

3) A fire containment system as claimed in claim 1, wherein the first sensor comprises a sprinkler.

4) A fire containment system as claimed in claim 3, wherein the sprinkler is in fluid coupling with the distribution system, and wherein activation thereof causes at least an initial dispersion of fire suppressant in the region associated therewith.

5) A fire containment system as claimed in claim 1, wherein the activated set comprises a plurality of ports situated to at least partially laterally surround the first region.

6) A fire containment system as claimed in claim 1, wherein the activated set further comprises ports above the first region, and/or below the first region.

7) A fire containment system as claimed in claim 1, wherein at least the first sensor, and/or one of the ports is coupled to the controller via wireless communication link.

8) A fire containment system as claimed in claim 1, further comprising a controllable master valve disposed to control fire suppressant flow to the distribution system, the master control valve being activated by the controller to introduce fire suppressant into the distribution system responsive to fire detection event.

9) A fire containment system as claimed in claim 1 wherein the controller selects the activated set according to a rule set.

10) A fire containment system as claimed in claim 9 wherein the rule set is dynamically changeable.

11) A fire containment system as claimed in claim 10 wherein the rule set is changed responsive to information related to conditions and/or content of at least one region of the protected volume.

12) A fire containment system as claimed in claim 11 further comprising at least one separate sensor selected from a weight sensor, a video sensor, a Radio Frequency Identification Sensor, a bar code sensor, a Quick Response reader, a tag reader, a manual or automated switch, and any combination thereof; the separate sensor being coupled to the controller and providing thereto condition information relating to condition of and/or content of the protected volume and/or its environment; wherein the rule set is being modified responsive to the condition information.

13) An activation reporting fire sprinkler comprising:
a body defining a fluid path therethrough, the fluid path having an inlet and an outlet;
a heat sensitive trigger activator;
a closure element disposed to block fluid flow via the outlet;
the heat sensitive element disposed to directly or indirectly maintain the closure element against the outlet, and allow the closure element to dislodge and transition the sprinkler to an open state allowing fluid flow from the inlet to the outlet, in response to the heat sensitive trigger being exposed to a temperature exceeding a predetermined threshold;
a sprinkler activation monitor having at least one mechanism which changes electrical state in response to the sprinkler being opened.

14) The activation reporting fire sprinkler as claimed in claim 13, wherein the mechanism comprises a switch and the change of state comprises opening or closing the switch.

15) The activation reporting fire sprinkler as claimed in claim 13, wherein the sprinkler activation monitor is selected from a surface movable by fluid flow through the sprinkler body, a switch sensing the status of the closure element, a wire disposed to be torn by the dislocation of the closure element, a pressure sensor disposed to sense pressure change resulting from sprinkler opening, a plurality of electrodes disposed to sense resistance and/or capacitance change caused by exposure to fluid flowing from the sprinkler, and any combination thereof.

16) A firefighting and/or fire containment system comprising:
a fire suppressant distribution system having a plurality of branches;
at least one of the branches having a valving arrangement comprising at least one status switch;
a fire alarm control panel (FACP) or a system controller capable at least activating an alarm in response to assertion of the switch;
a panel concentrator electrically coupled to the FACP and and/or the controller, the panel concentrator having logic and a wireless receiver;
a branch terminal coupled to the at least one switch, the branch terminal having logic and wireless transmitter, and being capable and configured of sensing the assertion of the switch and wirelessly transmitting a message indicating the assertion of the switch;
the panel concentrator being capable and configured at least to communicate the assertion of the switch to the FACP and/or controller responsive to receiving the corresponding message from the branch terminal.

17) A firefighting and/or fire suppression system as claimed in claim 16, wherein the branch terminal is further configured to transmit a periodical message indicating its operational status, the panel concentrator is further capable and configured to receive the operational status message and communicate to the FACP and/or controller the operational status or lack thereof of the branch terminal.

18) A firefighting and/or fire suppression system as claimed in claim 16, wherein the panel concentrator is integrated with the AFCP and/or the controller.

19) A firefighting and/or fire suppression system as claimed in claim 16, wherein the branch terminal comprises a receiver and the panel concentrator comprises a receiver for establishing bidirectional communications between the branch terminal and panel concentrator

20) A firefighting and/or fire suppression system as claimed in claim 16, wherein the panel concentrator is connectable to a plurality of branch terminals.
